(19) United States
(12) Patent Application Publication
(10) Pub. No.: US 2009/0099919 A1
(43) Pub. Date: Apr. 16, 2009

(54) METHOD, SYSTEM AND COMPUTER PROGRAM PRODUCT FOR FORMATTING AND DELIVERY OF PLAYLIST PRESENTATION CONTENT

(75) Inventors: John C. Schultheiss, Auburn, CA (US); Louis C. Douros, Auburn, CA (US); Adrian R. Pell, Auburn, CA (US); Kathryn M. Manley, Auburn, CA (US); John D. Stone, Auburn, CA (US); Jacob W. Jorgensen, Folsom, CA (US)

Correspondence Address: VENABLE LLP, P.O. BOX 34385, WASHINGTON, DC, 20043-9998, US

(73) Assignee: Freepath, Inc., Folsom, CA (US)

(21) Appl. No.: 12/176,169

(22) Filed: Jul. 18, 2008

Related U.S. Application Data
(60) Provisional application No. 60/950,570, filed on Jul. 18, 2007.

(51) Int. Cl. G06Q 30/00; G06F 3/048; G06F 17/30

(52) U.S. Cl. 705/14; 715/731; 715/769; 715/753; 705/27; 715/716; 705/1; 707/10; 707/E17.118

(57) ABSTRACT

An exemplary embodiment of the present invention sets forth a system, method and/or computer program product which may include a graphical user interface (GUI) application embodied on a computer readable medium, which when executed on a processor performs a method. The method may include receiving a playlist may include a plurality of content of a plurality of different formats; and enabling a presenter to seamlessly deliver a presentation of the plurality of content to an audience.

### CROSS REFERENCE TO RELATED APPLICATION

The present application is a non-provisional U.S. Application (Attorney Docket No. 98529-259760) that claims the benefit under 35 U.S.C. § 119(e) of U.S. Patent Application No. 60/950,570, filed Jul. 18, 2007, entitled “Adaptive Method and System for Commercial Delivery of Media and Application Content in a Distributed Computing Environment,” (Attorney Docket No. 98529-259940) of common assignee to the present invention, the contents of which are incorporated herein by reference in their entirety.

### BACKGROUND OF THE INVENTION

1. Field of the Invention

The present application relates generally to creation, presentation and delivery of content, and more particularly to the creation, presentation and delivery of disparate multimedia content.

2. Related Art

Electronic presentations generally serve a purpose of providing an agenda, a chronology, and are intended to enable efficient, consistent, information delivery. Presentation tools provide professional presentation of content by a presenter that complements a presenter's speech.

Conventional presentation tools, or presentation application programs, refer to computer software application programs, which may be used to display presentation information, generally in the form of a slide show. The presentation program may typically include an editor that may allow, e.g., text to be inserted into a presentation and formatted. Such tools may also allow inserting and manipulating graphic images and may provide a slide-show storyboard metaphor to allow display of presentation content. Conventional tools provide for “what you see is what you get” (WYSIWYG) environments to allow creating electronic presentations. Conventional presentation tools are generally proprietary in nature, and are intended for playback in a given proprietary computing environment associated with a given presentation tool.

Conventional presentation tools may be used to create presentations including, e.g., but may not be limited to, business professional (work-related), educational, entertainment, and general communication presentations, etc. Presentation programs may supplement or replace the use of earlier visual aid technologies, such as, e.g., but not limited to, brochures, pamphlets, handouts, a chalkboard, charts, posters, slides, or transparencies, etc. Content which may be used in presentations may include, e.g., but are not limited to, text, graphics, movies, and other objects positioned on individual pages, slides, or foils, to which they are sometimes referred. References to a slide, makes an analogy to slide projectors, which conventionally projected photographic still images. Presentation slides may be printed, displayed on-screen, or projected. An electronic presentation may be navigated at the command of a presenter, such as a <<page down>> or <<page up>> key stroke, for example. Transitions between slides may be animated, as may elements of the presentation slide itself.

Early WYSIWYG presentation tools included BRUNO and HP-Draw from Hewlett Packard in 1979, VCN ExecuVision in 1982-1983, which introduced the concept of clip art or an image library, and others, such as IBM Storyboard, COREL Presentations and LOTUS Freelance graphics.

Conventional digital photography and video tools, such as, e.g., Apple's iPhoto, also use a slide show format.

The increasing use of video projectors in churches has prompted the development of worship presentation programs with specific features such as a built-in Bible or databases for song lyrics.

Examples of presentation application programs include MICROSOFT POWERPOINT, COREL Presentations, Adobe Persuasion, AppleWorks, Authorstream, Beamer (LaTeX), Google Docs Presentations, Harvard Graphics, HyperCard, IBM Lotus Freelance Graphics, Apple Keynote, Kpresenter, Macromedia Director, MagicPoint, MatchWare Mediator, MatchWare OpenMind, OpenOffice.org, Impress, PicturesToExe, Scala Multimedia, Screencast, SongPro, Visual Understanding Environment (VUE), Zoho, among others, etc.

Since content and volumes of communications have continued to grow, managing content has increased in importance. Increasingly, social-based networks are being used to filter and share large amounts of content. Social networking sites such as, e.g., but not limited to, FACEBOOK, MYSPACE, LINKED IN, and others have arisen to allow sharing of content with different groups such as, e.g., but not limited to, friends.

### SUMMARY OF THE INVENTION

An exemplary embodiment of the present invention sets forth a system, method and/or computer program product which may include a graphical user interface (GUI) application embodied on a computer readable medium, which when executed on a processor performs a method. The method may include receiving a playlist may include a plurality of content of a plurality of different formats; and enabling a presenter to seamlessly deliver a presentation of the plurality of content to an audience.

According to one exemplary embodiment, the method may include receiving by a drag and drop interaction with a user the plurality of content being dropped on the GUI.

According to one exemplary embodiment, the method may further include allowing a change in order of the content of the playlist by drag and drop interaction of the user.

According to one exemplary embodiment, the method may further include providing a preview display for the presenter to view what the audience will see, wherein the preview display may include one or more of: a picture in a picture window; a blank shade; or a full screen window.

According to one exemplary embodiment, the enabling may further include receiving from the presenter an indication to proceed from a currently presented content of the plurality of content, to another of the plurality of content; identifying a format of the plurality of different formats, associated with the another of the plurality of content; activating in the background an instance of an application associated with the another of the plurality of content; and delivering for display using a common user interface the another of the plurality of content for viewing by the audience, once the instance is activated and the another the plurality of content is ready for display.

According to one exemplary embodiment, the presenter may be one or more of: a creator; a teacher; a sales person; a business person; a professor; a filmmaker; a student; a trainer; a speaker; a homemaker; a user; a worship leader; a pastor; a medical professional; an accountant; a certified public accountant (CPA); a legal professional; a government Employee; a military serviceman; a politician; a volunteer; a non-profit employee; an employee; an artist; a musician; a writer; a graphic designer; a broadcaster; a gamer; a virtual persona; an avatar; a podcaster; a spammer; a blogger; a disc jockey; a web designer; a software developer; an entrepreneur; an athlete; a coach; a administrator; a sole proprietor; a marketer; a network marketer; a scientist; an administrative assistant; a researcher; an executive; an analyst; a research analyst; a broadcaster; a video disc jockey; and a theater operator.

According to one exemplary embodiment, the method may further include interacting with an online collaboration service enabling one or more of: sharing of content among a plurality of users; storing of the playlist of the plurality of content; storing the plurality of content; viewing a published presentation of the playlist of the plurality of content; providing content to another user; receiving content from another user; providing presence information about a user; or providing relevance information about a user.

According to one exemplary embodiment, the method may further include providing relevance information about a user.

According to one exemplary embodiment, providing relevance information about a user may further include providing presence information; providing a user identifier of the viewing user; providing a delivery format associated with a viewing device of a viewing user; providing an availability of the viewing providing a location of the viewing user; providing a security level of the viewing user; providing status information of the viewing user; or providing an encryption level of the viewing user.

According to one exemplary embodiment, the plurality of different format types of the plurality of content may include: video content; audio content; audio-visual content; image based content; streaming content; spreadsheet content; still content; animated content; movie content; programming content; television content; digital versatile disk (DVD) content; portable document format (PDF) content; rich media website content; WEB 2.0 content; WEB 3.0 content; Voice-over-Internet Protocol (VoIP) content; broadcast content; FLASH-based content; slide show content; presentation slide content; MS POWERPOINT content; BLOGs; sales information content; web-based content; xML or HTML content; distance learning content; product information content; multimedia content; corporate communications content; network marketing content; collaborative meeting content; online community content; social networking content; virtual world content; instant messaging content; electronic mail content; messaging content; SMS and MMS messaging content; music content; sound effects content; stock photo content; background content; online presentation content; or podcast content.

According to one exemplary embodiment, the enabling may further include providing a presenter view of the plurality of content; or providing an audience view of the plurality of content.

According to one exemplary embodiment, the method may further include providing advertising content to the presenter.

According to one exemplary embodiment, the providing advertising content to the presenter may include providing advertising targeted at the presenter; providing sponsored advertising; providing banner advertising; or providing reach media format advertising.

According to one exemplary embodiment, the method may further include providing a media store for purchase of content by the presenter.

According to one exemplary embodiment, the method may further include providing a media store for purchase by the presenter of licensed content owned by third parties including content affiliates.

According to one exemplary embodiment, the method may further include delivering interactively by the presenter, for display using a common user interface content for viewing by the audience, may include one or more of: identifying a device format of the audience; formatting the content for the device format; or delivering the content in the device format to the audience.

According to one exemplary embodiment, the device format may further include a personal digital assistant format; a browser format; a computer display format; a communications device display format; a telephony device display format; a display device format; a VGA format; a SVGA format; an XVGA format; a megapel format; an HDTV format; a DVI format; an NTSC format; or a PAL format.

Another exemplary embodiment of the present invention sets forth a method for formatting content on a distributed computing environment. The method may include receiving into a playlist a plurality of content of a plurality of different formats from a user via a user interface; and enabling a presenter to seamlessly deliver a presentation of the plurality of content to an audience.

According to one exemplary embodiment, the method may further include determining the capabilities of a playback platform and preparing the plurality of content based on the capabilities of the playback platform.

According to one exemplary embodiment, the method may further include opening the playlist; displaying the content on a playback platform; and managing the displaying of the content on the playback platform.

According to one exemplary embodiment, the method may further include preparing the playback platform to display the plurality of content of the playlist.

According to one exemplary embodiment, the preparing may include identifying a format associated with one or more of the plurality of content; activating, in the background, an instance of an application associated with the one or more of the plurality of content; and delivering for display the one or more of the plurality of content for viewing by the audience, once the instance is activated and the one or more of the plurality of content is ready for display.

According to one exemplary embodiment, the first software program and the playback platform are located on a common devices.

According to one exemplary embodiment, the first software program and the playback platform are located on separate device.

According to one exemplary embodiment, preparing the playback platform to display the plurality of content of a plurality of different formats may include: a unified presentation software application identifying, acquiring, and executing a second software program, wherein the second software program is needed to open one of the plurality of content.

According to one exemplary embodiment, one or more of the plurality of content of a plurality of different formats is opened in unified presentation software application with the assistance of a second software application.

According to one exemplary embodiment, the method may further include publishing the plurality of content.

According to one exemplary embodiment, publishing may include one or more of: formatting the plurality of content for distribution; formatting the plurality of content for display; flattening the plurality of content into a file; flattening the plurality of content into a given format; or flattening the plurality of content for purposes of one or more of: displaying the plurality of content on one or more playback platforms; or distributing the single file to one or more playback platforms.

According to one exemplary embodiment, the method may further include publishing the playlist on one or more of a personal website, a commercial website, a government website, a non-profit website, a social networking website, or an internet based application.

According to one exemplary embodiment, the method may further include storing the playlist on one or more of a personal website, a commercial website, a government website, a non-profit website, a social networking website, or an internet based application.

According to one exemplary embodiment, the method may further include selling the playlist on one or more of: a personal website, a commercial website, a government website, a non-profit website, a social networking website, an open content environment, or an internet based application.

According to one exemplary embodiment, the plurality of content of a plurality of different formats relates to one or more of commercial information; training information; or personal information.

According to one exemplary embodiment, the preparing a playlist is performed via at least one device.

According to one exemplary embodiment, the preparing a playlist is performed via a plurality of devices.

According to one exemplary embodiment, the method may further include retrieving and complying with intellectual property rights for the various media files referenced in the playlist.

According to one exemplary embodiment, the plurality of content of a plurality of different formats may include one or more of: syndicated content; video content; audio content; text content; or streaming content.

According to one exemplary embodiment, the method is performed by one or more of: a single machine running a process; a single machine running multiple processes; multiple machines running at least one process each; or multiple machines running multiple processes.

According to one exemplary embodiment, the method may further include saving the presentation in an internet accessible database.

According to yet another exemplary embodiment, a method for delivering content on a distributed computing environment, the method may include determining the capabilities of a playback platform; preparing the playback platform to display a playlist, may include a plurality of content of a plurality of different formats, via a unified presentation software application, based on the plurality of content of a plurality of different formats and the capabilities of the playback platform; preparing the plurality of content of a plurality of different formats to be displayed on the playback platform, via the unified presentation software application, based on the plurality of content of a plurality of different formats and the capabilities of the playback platform; opening the playlist via the unified presentation software application; displaying the playlist on the playback platform, via the unified presentation software application; and managing the displaying of the playlist on the playback platform.

According to one exemplary embodiment, the method may further include receiving the playlist based on one or more of: relevance information about a user; or presence information about a user.

According to one exemplary embodiment, the method may further include receiving the playlist from one or more of: a personal website, a commercial website, a government website, a non-profit website, a social networking website, an open content environment, or an internet based application.

### BRIEF DESCRIPTION OF THE DRAWINGS

The foregoing and other features and advantages of the invention will be apparent from the following, more particular description of various exemplary embodiments including a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of an exemplary unified presentation system environment according to an exemplary embodiment of the present invention;

FIG. 2 depicts an exemplary software architecture illustrating an exemplary unified presentation system according to an exemplary embodiment of the present invention;

FIG. 3 depicts an exemplary computer system environment that may be used in implementing an exemplary embodiment of the various exemplary devices of the present invention;

FIG. 4 depicts an exemplary screenshot of an exemplary embodiment of a graphical user interface of an exemplary unified presentation system;

FIG. 5 depicts an exemplary diagram of an exemplary embodiment of a exemplary mashup application.

FIG. 6 depicts an exemplary diagram of an exemplary embodiment of a format application;

FIG. 7 depicts an exemplary diagram of an exemplary embodiment of a delivery application;

FIG. 8 depicts an exemplary embodiment of a flowchart for an exemplary technique by which the mashup application may perform an exemplary mashup operation;

FIG. 9 depicts an exemplary embodiment of a flowchart for an exemplary technique by which the format application 108b may perform a format operation;

FIG. 10 depicts an exemplary embodiment of a flowchart depicting an exemplary delivery operation, according to an exemplary embodiment of the present invention;

FIG. 11 depicts an exemplary embodiment of a flowchart depicting an exemplary content operation, according to an exemplary embodiment of the present invention;

FIG. 12 depicts an exemplary embodiment of a flowchart depicting an exemplary presentation operation, according to an exemplary embodiment of the present invention;

FIG. 13 depicts an exemplary diagram illustrating an exemplary unified presentation system environment according to an exemplary embodiment of the present invention;

FIGS. 14 and 14B collectively depict a screenshot of an exemplary GUI illustrating an exemplary seamless playback of slides of content for an exemplary embodiment of a unified presentation system;

FIG. 15 depicts an exemplary screenshot of an exemplary GUI illustrating an exemplary import via a browse of an exemplary embodiment of a unified presentation system;

FIG. 16 depicts an exemplary screenshot of an exemplary GUI illustrating exemplary audio controls for an application of an exemplary embodiment of a unified presentation system;

FIG. 17 depicts an exemplary screenshot of an exemplary GUI illustrating an exemplary seamless worldwide web browser controls for application of an exemplary embodiment of a unified presentation system;

FIG. 18 depicts an exemplary screenshot of an exemplary GUI illustrating an exemplary seamless video controls for an application of an exemplary embodiment of a unified presentation system;

FIG. 19 depicts another exemplary embodiment of an exemplary screenshot of an exemplary multi-track playlist panel, an exemplary media store panel, an exemplary search tool panel, and an exemplary publishing panel for an exemplary embodiment of a unified presentation system;

FIGS. 20 A and B collectively depict exemplary screen shots of exemplary presenter and audience views of an exemplary embodiment of a unified presentation system;

FIGS. 21 A and B collectively depict an exemplary embodiment of a unified presentation system;

FIG. 22 depicts an exemplary of a diagram illustrating an exemplary collaborative authoring of a exemplary presentation for an exemplary embodiment of a unified presentation system; and

FIG. 23 depicts an exemplary access control table as may be included according to one exemplary embodiment.

### DETAILED DESCRIPTION OF VARIOUS EXEMPLARY EMBODIMENTS OF THE PRESENT INVENTION

Various exemplary embodiments of the invention including a preferred embodiment of the present invention may be discussed in detail below. While specific exemplary embodiments may be discussed, it should be understood that this may be done for illustration purposes only. A person skilled in the relevant art will recognize that other components and configurations can be used without parting from the spirit and scope of the invention.

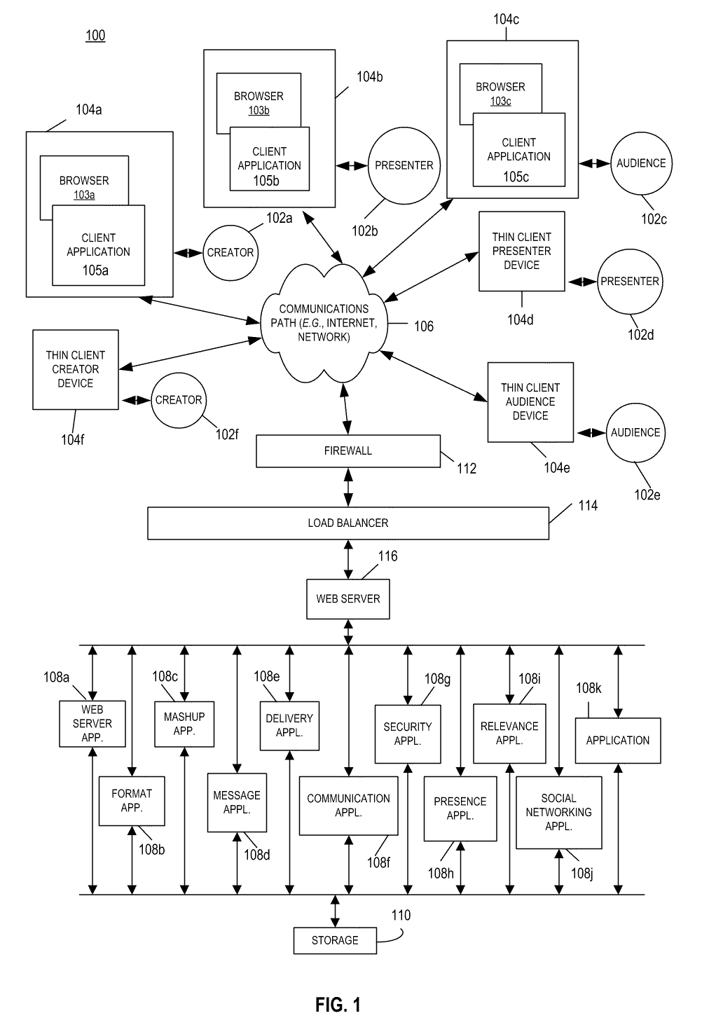

In an exemplary embodiment, a unified presentation system, as illustrated and described further below with reference to FIG. 1, may enable a presenter 102b to prepare and deliver a presentation including a playlist, containing a broad range of multimedia or other content, to a playback or display platform or device where the playlist can be prepared, viewed, and/or edited by a creator 102a, the presenter 102b, and/or presented to audience member(s) 102c in a seamless manner. In order to deliver the playlist, one or more applications 108 may, e.g., but not limited to, access, add, edit, modify and/or publish the content and/or the manipulate the display or playback platform. The one or more applications 108 may cooperate with the GUI to access, open, edit, modify and/or present the content.

A presenter 102b may refer to a user who may create or present a presentation including a playlist to a viewer or audience member. The presenter 102b may include, e.g., but is not limited to, a teacher, a sales person, a hobbyist, a business person, a professor, a filmmaker, a student, a trainer, a speaker, a pastor, a worship leader, minister, religious leader, a homemaker, etc. The presenter 102b may be any user who desires to convey content to an audience of one or more member(s).

A audience member may refer to a user who views a created playlist. A audience member may be, e.g., but is not limited to, a teacher, a sales person, a hobbyist, a business person, a professor, a filmmaker, a student, a trainer, a speaker, and/or a homemaker.

A playlist may refer to a collection of content. The collection of content in an exemplary embodiment may be multimedia content. The collection may include a sequence, a chronology, transitions, etc.

Content may relate to, e.g., but is not limited to, commercial or noncommercial information, multimedia information, training information, religious information, personal information, etc. Content may include, e.g., but is not limited to, to any type of data file, data feed, or information source, etc. Examples of content may include, e.g., but not be limited to, media files, streams, video content, audio content, image content, audio-visual content, common business documents, steaming data sources (such as, e.g., but not limited, webcam content), data collection devices, still content, IP TV stream content, digital video recorder (DVR) content, animated content, programming content, television content digital versatile disk (DVD) content, rich media websites, WEB 2.0 content, WEB 3.0 content, web content Voice-over-Internet Protocol (VoIP) content, broadcast content, FLASH-based content, slide show content, syndicated content, subscription based content, real simple syndication (RSS) feeds, presentation slide content, MS POWERPOINT content, BLOG content, micro BLOG content, sales information content, web-based content, extensible markup language (xML) or hypertext markup language (HTML) content, Really Simple Syndication (RSS) content, distance learning content, personal programming content, product information content, multimedia content, corporate communications content, network marketing content, collaborative content, collaborative meeting content, online community content, social networking content, virtual world content, instant messaging content, Extensible Messaging and Presence Protocol (XMPP) IM stream, rich media IM stream, livestream content, electronic mail content, messaging content, short message service (SMS) and multimedia message service (MMS) messaging content, music content, sound effects content, stock photo content, background content, online presentation content, podcast content, spreadsheet content, text documents, word processing content, and portable document format (PDF) content.

A playback platform or device 104c, 104e may refer to a device with which an audience may view a delivered presentation including the playlist. A playback platform may include, e.g., but may not be limited to, a computing device, a communication device, a telephone device, a wireless device, a networked device, a client browser based workstation, a think client, a network appliance, a display, a projector, a portable device, a personal computer, a television, a monitor, a portable audio device, a portable video device, a portable audio-visual device, and/or a game console etc.

FIG. 1 depicts an exemplary diagram 100 illustrating an exemplary embodiment of an exemplary unified presentation system hardware and architecture environment according to an exemplary embodiment of the present invention. Although illustrated in an exemplary application service provider (ASP) client server network, any other well know network design such as, e.g., but not limited to, peer-to-peer, client-server, hierarchical, software as a service (SAS), standalone, distributed enterprise, etc. may also be used.

According to an exemplary embodiment, one or more application devices including, web server application device 108a, format application device 108b, mashup application device 108c, message application device 108d, delivery application device 108e, communication application device 108f, security application device 108g, presence application device 108h, relevance application device 108i, social networking application device 108j, and application device 108k (collectively referred to as ‘application devices 108’), may include, e.g., but are not limited to, storing, managing, modifying, formatting, delivery, etc. content. Application devices 108 may include, e.g., but may not be limited to, application servers. According to an exemplary embodiment, as illustrated in diagram 100, application devices 108 may be used to distribute formatted content to one or more exemplary devices such as, but not limited to, creator device 104a, presenter device 104b, audience device 104c, thin client presenter device 104d, thin client audience device 104e, and thin client creator device 104f (collectively referred to ‘devices 104’), for interactive editing or viewing by one or more users 102a, 102b, 102c, 102d, 102e, and 102f (collectively referred to as ‘users 102’).

According to an exemplary embodiment, the system 100 may be represented by a client-server network design or topology where the application devices 108 may be coupled, via, e.g., but not limited to, one or more web server device(s) 116, one or more load balancing devices 114 and/or one or more firewall(s) 112, as well as a communications network 106 (such as, e.g., a network, or the Internet), to devices 104. Devices 104 may include, according to an exemplary embodiment, the creator device 104a, a presenter device 104b, an audience device 104c, a thin client presenter device 104d, a thin client audience device 104e, and a thin client creator device 104f (collectively 104) Devices of 104 may in some exemplary embodiments include a browser 103 which may in certain exemplary embodiments interact with a server application as well as interpret code such as, e.g., HTML, XML, Flash etc. Devices 104 may be coupled to one or more exemplary storage media 110 such as, e.g., but not limited to, a computer readable medium, such as, e.g. but not limited to, a storage, a memory, a flash memory, a fileserver, a storage area network (SAN), a compact disc read only memory (CD-ROM), and/or a digital versatile disk (DVD), etc.

According to another exemplary embodiment (not shown), the devices 104 could be represented by any of a number of well-known hardware network architectures and/or topologies including, but not limited to, a peer-to-peer network design, a client-server based architecture, an application services (ASP) based offering, a software as a service (SaaS) by which notification and/or informational content may be distributed from one computing device to another. Any other hardware architecture such as, e.g., but not limited to, a services oriented architecture (SOA), according to an exemplary embodiment of the present invention.

As shown in FIG. 1, in an exemplary embodiment, an end user 102, such as, e.g., but not limited to a creator 102a, 102f, a presenter 102b, 102d, or an audience member 102c, 102e, may interact with at least one application 108 via a client device, such as devices 104, which may provide an interface to the user 102 such as, e.g., but not limited to, a graphical user interface (GUI), which may execute on the device 104 via a client application or applet 105 (in the case of devices 104a, 104b, and 104c), which may, in an exemplary embodiment, include a browser-based application 103, or via another application, applet, or device (in the case of thin client devices 104d, 104e, 104f).

According to an exemplary embodiment, one or more applications 108 may format and deliver content, via the communications path 106, to and from devices 104. In an exemplary embodiment, an entity 102 may be coupled to the applications 108 via one or more devices including, e.g., but not limited to, a firewall 112, one or more load balancer(s) 114, and one or more web server(s) 116. The applications 108 may include storage or may access a storage device 110 such as, e.g., but not limited to, a hard drive or a database, etc. The data storage device 118 may access, and/or store content, as described herein.

The devices 104 may be coupled to one another over a communications path 106 such as, e.g., but not limited to, an intranet, the Internet or a network. The devices 104 may be coupled to one another and may communicate via one or more applications 108 which may include a browser 105 such as, e.g., but not limited to, an internet browser, which may include, e.g., but not limited to, Microsoft Internet Explorer, Netscape Navigator, Mozilla, and FireFox, utilizing the standard Internet hypertext transfer protocol (“HTTP”), extensible markup language (XML), and universal resource locators (“URLs”). Although the use of HTTP may be described herein, any well known transport protocol may be used without deviating from the spirit or scope of the invention.

According to one exemplary embodiment, audience device 104c, 104e may be referred to as a playback platform 104c, 104e and may be configured to provide the audience 102c, 102e a particular view of a presentation as controlled by presenter 102b, 102d.

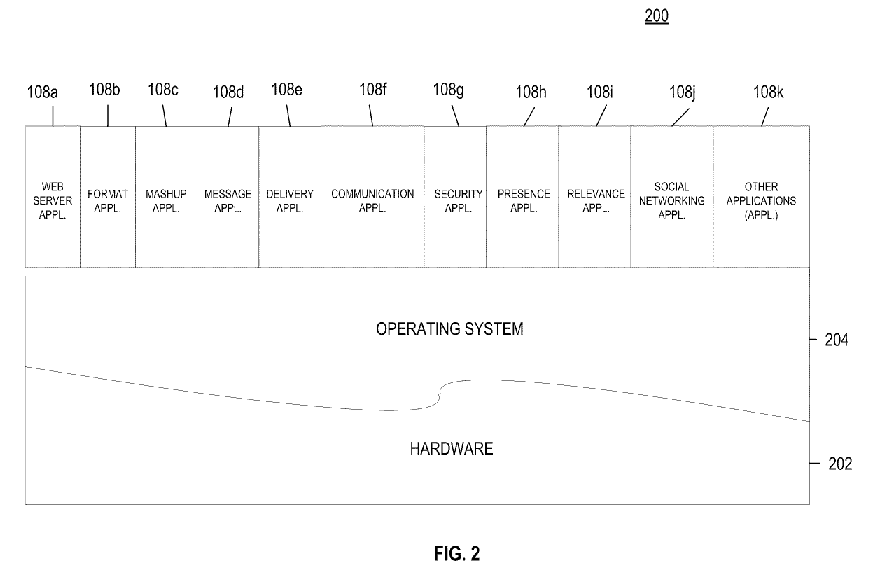

FIG. 2 depicts an exemplary diagram 200 illustrating an exemplary software architecture that may be used with the hardware architecture illustrated in diagram 100 of the exemplary unified presentation system according to an exemplary embodiment of the present invention. An exemplary unified presentation system may include a hardware layer 202, an operating system layer 204, and at least one application 108. Exemplary applications may include a web server application 108a, a format application 108b, a mashup application 108c, a message application 108d, a delivery application 108e, a communication application 108f, a security application 108g, a presence application 108h, a relevance application 108i, a social/professional networking application 108j, and an application 108k (collectively referred to as ‘applications 108’). Each application is discussed in further detail below. Although applications 108 are depicted as executing on one hardware layer 202, hardware 202 may include one or more hardware, and/or network devices.

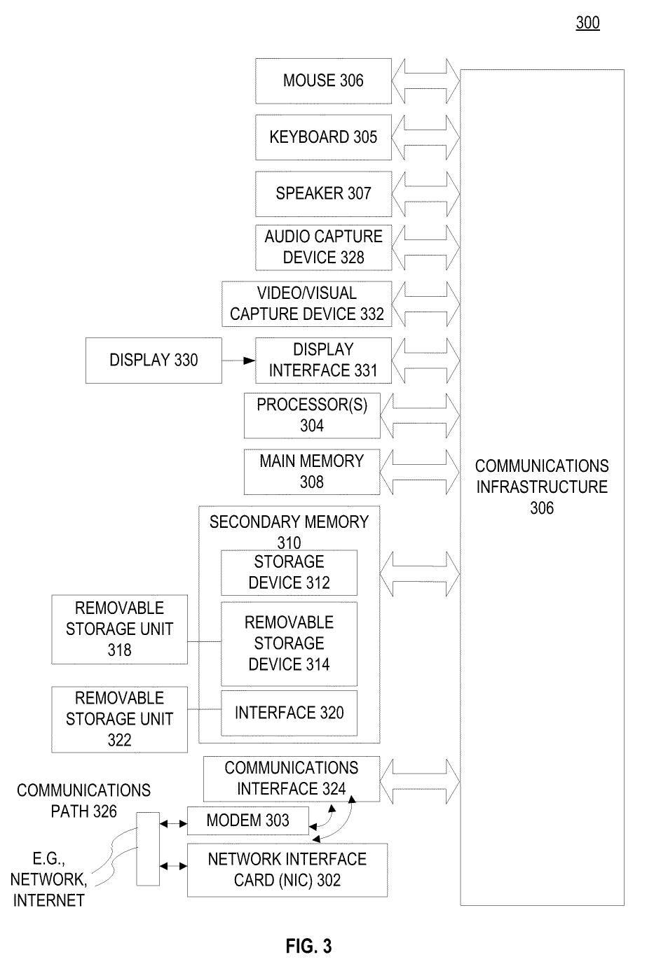

FIG. 3 depicts diagram 300 illustrating an exemplary computer system such as may be used in devices 104, 108, 106, 112, 114, 116, 110, etc. that may be used in implementing an exemplary embodiment of the present invention. Specifically, FIG. 3 depicts an exemplary embodiment of a computer system 300 that may be used in computing devices such as, e.g., but not limited to, a client and/or a server, etc., according to an exemplary embodiment of the present invention. FIG. 3 depicts an exemplary embodiment of a computer system that may be used as the devices 104, web server 116, application device/platforms 108, etc. The present invention (or any part(s) or function(s) thereof) may be implemented using hardware, software, firmware, and/or a combination thereof and may be implemented in one or more computer systems or other processing systems. In fact, in one exemplary embodiment, the invention may be directed toward one or more computer systems capable of carrying out the functionality described herein. An example of a computer system 300 is shown in FIG. 3, depicting an exemplary embodiment of a block diagram of an exemplary computer system useful for implementing the present invention. Specifically, FIG. 3 illustrates an example computer 300, which in an exemplary embodiment may be, e.g., but not limited to, a personal computer (PC) system running an operating system such as, e.g., (but not limited to) MICROSOFT® WINDOWS® NT/98/2000/XP/CE/ME/VISTA/etc. available from MICROSOFT® Corporation of Redmond, Wash., U.S.A. However, the invention may not be limited to these platforms. Instead, the invention may be implemented on any appropriate computer system running any appropriate operating system such as, e.g., but not limited to, an Apple computer executing MAC OS. In one exemplary embodiment, the present invention may be implemented on a computer system operating as discussed herein. An exemplary computer system, computer 300 is shown in FIG. 3. Other exemplary computer systems may contain additional components, such as, e.g., but not limited to, a computing device, a communications device, mobile phone, a telephony device, an iPhone (available from Apple of Cupertine, Calif. USA), a 3G wireless device, a wireless device, a telephone, a personal digital assistant (PDA), a personal computer (PC), a handheld device, a portable device, an interactive television device (iTV), a digital video recorder (DVD), client workstations, thin clients, thick clients, fat clients, proxy servers, network communication servers, remote access devices, client computers, server computers, peer-to-peer devices, routers, gateways, web servers, data, media, audio, video, telephony or streaming technology servers, game consoles, content delivery systems, etc., may also be implemented using a computer such as that shown in FIG. 3. In an exemplary embodiment, services may be provided on demand using, e.g., but not limited to, an interactive television device (iTV), a video on demand system (VOD), via a digital video recorder (DVR), and/or other on demand viewing system.

The computer system 300 may include one or more processors, such as, e.g., but not limited to, processor(s) 304. The processor(s) 304 may be coupled to and/or connected to a communication infrastructure 306 (e.g., but not limited to, a communications bus, cross-over bar, or network, etc.). Various exemplary embodiments may be described in terms of this exemplary computer system. After reading this description, it may become apparent to a person skilled in the relevant art(s) how to implement the invention using other computer systems and/or architectures.

Computer system 300 may include a display interface 331 that may forward, e.g., but not limited to, graphics, text, and other data, etc., from the communication infrastructure 306 (or from a frame buffer, etc., not shown) for display on the display unit 330.

The computer system 300 may also include, e.g., but may not be limited to, a main memory 308, random access memory (RAM), and a secondary memory 310, etc. The secondary memory 310 may include a computer readable medium such as, for example, (but not limited to) a hard disk drive 312 and/or a removable storage drive 314, representing a floppy diskette drive, a magnetic tape drive, an optical disk drive, magneto-optical, a compact disk drive CD-ROM, etc. The removable storage drive 314 may, e.g., but not limited to, read from and/or write to a removable storage unit 318 in a well known manner. Removable storage unit 318, also called a program storage device or a computer program product, may represent, e.g., but not limited to, a floppy disk, magnetic tape, optical disk, compact disk, etc. which may be read from and written to by removable storage drive 314. As may be appreciated, the removable storage unit 318 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM), flash memory, non-volatile memory, or a digital versatile disk (DVD); digital video recorder disk (DVR); a magnetic tape; and a memory chip, etc.

In alternative exemplary embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 322 and interfaces 320, which may allow software and data to be transferred from the removable storage unit 322 to computer system 300.

Computer 300 may also include an input device such as, e.g., (but not limited to) a mouse 306 or other pointing device such as a digitizer, an audio capture device 328 (such as, e.g., but not limited to, a microphone), an image video/visual capture device 332 (such as, e.g., but not limited to, a camera), and a keyboard 305 and/or other data entry device (not shown), etc.

Computer 300 may also include output devices, such as, e.g., (but not limited to) display 330, display interface 331, and/or a speaker 307, etc. Other output devices may also be used, including, e.g., but not limited to, a printer, etc. Computer 300 may include input/output (I/O) devices such as, e.g., (but not limited to) communications interface 324 and communications path 326, etc. These devices may include, e.g., but not limited to, a network interface card 302, and modem(s) 303. Communications interface 374 may allow software and data to be transferred between computer system 300 and external devices.

In this document, the terms “computer program medium” and “computer readable medium” may be used to generally refer to media such as, e.g., but not limited to removable storage drive 314, a hard disk installed in hard disk drive 312, a storage area network (SAN), database, etc. These computer program products may provide software to computer system 300. The invention may be directed to such computer program products. In some cases, a computer program product may include software which may be distributed via a communication system and then may be stored on a storage device.

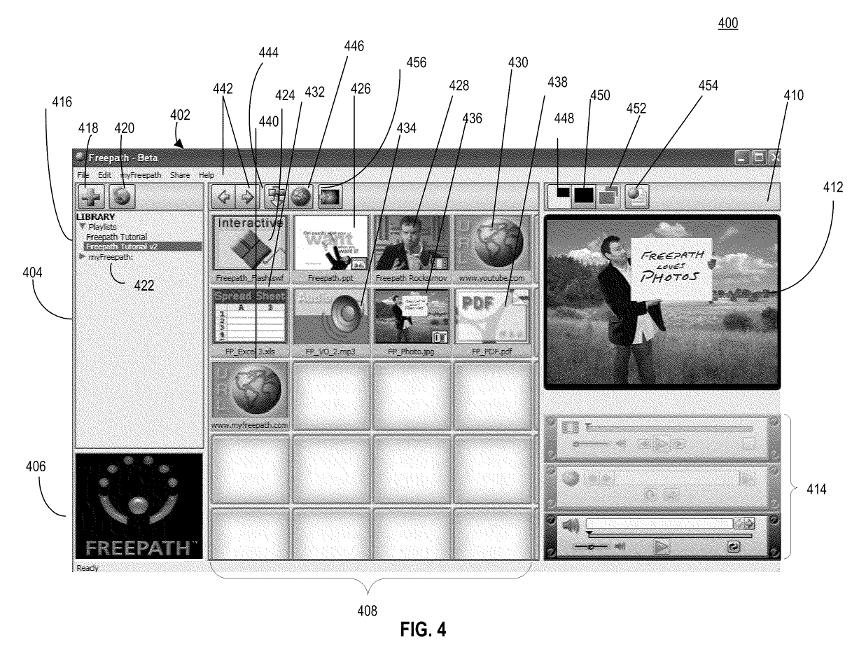

FIG. 4 depicts a diagram 400 of an exemplary screenshot of an exemplary embodiment of a unified presentation system 400. The exemplary embodiment of the unified presentation system 400 may be in the form of a GUI 402. According to an exemplary embodiment, diagram 400 may indicate a view of a GUI 402 of the creator client application 105a or presenter client application 105b. GUI 402 may contain, e.g., but is not limited to, a library panel 404, an information space 406, a playlist panel 408, exemplary display controls 410, preview window 412, and exemplary content controls or rack 414.

Library 404 may allow a user to select a playlist 408 and/or content. The playlist 408 and/or content may be selected is several ways. One or more playlists 408 and/or content may be mapped to the unified presentation system 400. ‘Freepath Tutorial 2’ 416 may reside in a storage device associated with the unified presentation system 400, such as, e.g., but not limited to, a hard drive or network drive. Additional playlist 408 and/or content may be mapped to the unified presentation system 400 via an internet based application. For example, according to an exemplary embodiment, ‘myfreepath’ 422, an exemplary online collaboration service available from FREEPATH of Folsom, Calif. USA, may be an exemplary network or internet based application in which users can access, store, share, and/or publish playlists and/or content. Playlists 408 and/or content may be selected from a storage device associated with the unified presentation system 400, such as, e.g., but not limited to, a hard drive or network drive, via icon 418. Playlists 408 may also be selected from the internet or an internet based store via icon 420. Each of these topics is discussed in further detail below.

Information space 406 may be useful to display information to a user. The information may include, e.g., but is not limited to, information on how to use the GUI, information relating to a users playlist, and/or commercial advertisements, etc. For example information space 406 may be used to provide content available from, e.g., but not limited to, an ad server, including, e.g. banner ads, targeted search results, user-tailored ads, demographic and/or psychographic tailored ads/content, search results, optimized results, results tailored to maximize revenue to a provider of the application software, content store, commerce enabled content, product and/or service offering content, webcam content, audio and/or video stream, etc. Information displayed in the information space 406 may be , e.g., but is not limited to, targeted towards the user. Information may be targeted to a user based on, e.g., but not limited to, a users available presence information and/or relevance information.

Playlist 408, an exemplary embodiment, may contain content of a plurality of different types/formats. For example, playlist 408 may contain, e.g., but is not limited to, exemplary content elements, including, Shockwave Flash content 424, MICROSOFT® PowerPoint content 426, movie content 428, internet based content 430 and 440, MICROSOFT® Excel spreadsheet content 432, audio content 434, image content 436, and portable document format (PDF) content 438. The content may be displayed as, e.g., but not limited to, thumbnails in the playlist 408. The content may be arranged in a presentation order in the playlist.

In an exemplary embodiment, a user may scroll through the content by, e.g., but not limited to, selecting a thumbnail directly and/or by use of scroll icons 442. Once selected, a preview of the content may appear in preview window 412. According to an exemplary embodiment the preview panel 412 may indicate what the audience 102c, 102e would view for a given element of playlist 408. A user may also edit/modify selected content via the preview window 412 or media controls 414. Exemplary media controls 414 may allow a user to, e.g., but not limited to, determine what part(s) of the selected content will be displayed to an audience and whether the selected content will be displayed before, during, or after other content in the playlist (e.g. multi-content playback) and how the content may be presented or accessed.

In an exemplary embodiment, a user may add content to the playlist 408 in several ways. A user may use icon 444, which may, e.g., but is not limited to, allow the user to select content from a storage device, such as, e.g., but not limited to, a hard drive or network drive, purchase/license content from an internet based application, and/or another user. A user may also select icon 446, which may, e.g., but is not limited to, allow a user to select content from the internet or an internet based application. In another exemplary embodiment, content may be dragged and dropped on the playlist panel 408 to be inserted into the playlist 408. As shown, an exemplary single track playlists is illustrated, however multiple track playlists may also be provided and/or displayed.

In an exemplary embodiment, a user 102, such as, e.g., creator 102a, 102f, or presenter 102b, 102d, may arrange the presentation order of content within a playlist. A user may arrange the order of content within a playlist 408 via, e.g., but not limited to, a drag and drop interaction and/or a drop down menu. Exemplary display controls 410 may control what the user 102 and/or the audience 102c, 102e sees. Icon 448 may allow the user 102 to prepare a playlist for display using GUI 402, as it is depicted in FIG. 4. Icon 450 may allow the user 102 to present the playlist, via GUI 402, in a full screen preview mode. Icon 452 may allow a user 102 to present the playlist 408 to an audience using one or more playback platforms that may be separate from the display that is displaying GUI 402. Icon 452 may allow, for example, the audience 102c, 102e to see a full screen version of the playlist while the user presenter 102b, 102d interacts with the playlist using GUI 402, as it is depicted in FIG. 4. Icon 452 may allow the user to, for example, interact with the content in the playlist out of the audience's view. While a playlist 408 is being presented a presenter user 102b, 102d may, for example, select content to be displayed to the audience user 102c, 102e in a non-linear order, sequentially, or add content to the playlist, and/or edit content in the playlist out of the view of audience 102c, 102e. The presenter user 102b, 102d may utilize icon 456 to, e.g., prevent the playback platform 104c, 104e from displaying content to audience user 102c, 102e while editing or proceeding through the playlist via GUI 402, that is being simultaneously presented. The presenter may use icon 454 to publish a playlist 408 in desired format.

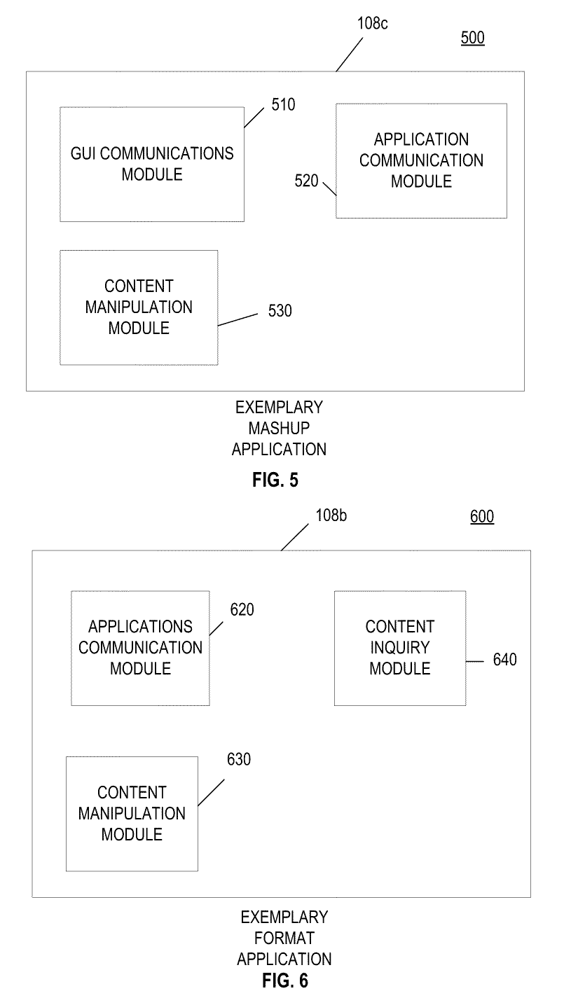

FIG. 5 depicts a diagram 500 illustrating an exemplary embodiment of a mashup application 108c. Mashup application 108c, according to an exemplary embodiment, may include, e.g., but may not be limited to, a GUI communications module 510, an applications communication module 520, and/or a content manipulation module 530, etc.

The exemplary GUI communication module 510, in an exemplary embodiment, may facilitate communications between the mashup application 108c and client GUI 402 according to an exemplary embodiment. The GUI may enable a presenter to, e.g., but not limited to, add and/or edit a playlist 408 in conjunction with the mashup application 108c, the application communication module 520, and/or the content manipulation module 530, etc.

The exemplary application communication module 520, in an exemplary embodiment, may facilitate the communication between the mashup application 108c and one or more of the remaining or other applications 108. According to an exemplary embodiment, a communication stack may be used for communication including, e.g., data packet communications between applications, client and server applications, and advanced program to program (APPC) communications, presentation communications, playlist messaging, and live content stream communications.

The content manipulation module 530, in an exemplary embodiment, may enable a presenter 102b, 102d to, e.g., but not limited to, add content to the playlist 402, edit content in the playlist, modify the content in the playlist, modify the playlist 402 itself, and/or edit the playlist 402 itself. A presenter may add content to the playlist 402 from, e.g., but not limited to, storage, a computer hard drive, a network drive, the internet, a content store, a camera, a video recorder, another presenter, and/or an audio recorder, etc. A presenter 102b, 102d may also add content place holders. In an exemplary embodiment, a content placeholder may be a placeholder for, e.g., but not limited to, live content, streaming content, and/or future content. As the content becomes available, it may take the place of the placeholder in the playlist. A presenter may add content to the playlist by, e.g., but not limited to, executing a drag and drop operation in the GUI, and/or selecting the content in a pull down menu in the GUI, etc.

A presenter 102b, 102d may edit/modify content in the playlist 408 via the GUI 402 by, e.g., but not limited to, editing/modifying the content in the content's native form.

A presenter 102b, 102d may edit/modify a playlist 408 via the GUI 402 by, e.g., but not limited to, placing the content in an order to be displayed, identifying a portion(s) of individual content to be displayed, identifying content to be displayed/output simultaneously, adding transition and/or animation sequences between content, identifying where and/or when to begin displaying and/or identifying where and/or when to end displaying content. In the case of multi-track content, relative cut-ins and cut-outs of content in multiple tracks may be manipulated, according to an exemplary embodiment.

In an exemplary embodiment, identifying a portion of individual content to be displayed may include identifying where and/or when to start playing audio content, identifying where and/or when to stop playing audio content, identifying where and/or when to start playing video content, identifying where and/or when to stop playing video content, identifying where and/or when to start displaying content, and/or identifying where and/or when to stop displaying content.

In an exemplary embodiment, identifying content to be displayed and/or outputted, e.g., overlapping, and/or simultaneously, may include, e.g., but is not limited to, identifying a first element of content, or a portion thereof, to be overlaid or simultaneously output with a second element of content, or portion thereof. During presentation of the playlist, the first content element and the second content element may be simultaneously displayed and/or output to the audience. In an exemplary embodiment, the first content element may be, e.g., but is not limited to, an audio content element to be played and the second content element may be, e.g., but is not limited to, an image content element to be displayed. In another exemplary embodiment, the first content element may be, e.g., but is not limited to, a video content element such as, e.g., background video and the second content element may be, e.g., but is not limited to, an audio content element. In yet another exemplary embodiment, the first content element may be, e.g., but is not limited to, first audio content element such as music and the second content element may be, e.g., but is not limited to, second audio content element such as, e.g., narration, etc. Any other variations of multiple tracks of overlapping content may be provided as will be apparent to those skilled in the art.

FIG. 6 depicts a diagram 600 illustrating an exemplary diagram of an exemplary embodiment of a format application 108b. The format application 108b may include, e.g., but is not limited to, an application communication module 620, a content inquiry module 640, and/or a content manipulation module 630, etc.

The application communication module 620 may facilitate the communication between the format application 108b and one or more of the remaining or other applications 108. The format application 108b may, for example, but not limited to, communicate with, e.g., the delivery application 108e in order to, e.g., but not limited to, determine the capabilities of a playback platform, etc.

The content manipulation module 630, in an exemplary embodiment, may enable the format application 108b, or a presentation creator 102a, 102f to, e.g., but not limited to, add, edit, and/or modify content in a playlist. A format application 108b may add content to the playlist 408 from, e.g., but not limited to, storage, a computer hard drive, a network drive, the internet, a content store, a camera, a video recorder, and/or an audio recorder, etc. The format application 108b may add content, such as, e.g., but not limited to, proxies of content and/or additional components of content, when, for example, it is determined that the playback platform 104c, 104e of the audience 102c, 102e, is unable to display the content in its present form. This determination may be based on the communication between the format application 108b and the delivery application 108e, in an exemplary embodiment.

The content manipulation module 630, in an exemplary embodiment, may edit and/or modify content by, e.g., but not limited to, reformatting the content altering the content in its native form. A format application 108b may modify content in the playlist when, e.g., but not limited to, the playback platform is not capable of displaying content in its present form. Modified versions of the playlist 408 content, e.g., produced by the format application 108b may be saved for future use in, e.g., but not limited to, a temporary location accessible to the format application 108b so as to avoid changing the original content file. In one exemplary embodiment, depending on, e.g., access control list (ACL) rights, and/or digital rights management (DRM), the format of a given content element may be modified, and may create a different version of the given content element, so as not to overwrite the element.

The content inquiry module 640, in an exemplary embodiment, may enable the format application 108b to, e.g., but not limited to, determine a content type/format and/or ensure that the playback platform is able to display the content, etc. The content inquiry module 630 may ensure that the format application 108b is able to display the content by, e.g., but not limited to, identifying, retrieving and/or installing an application which may be necessary to access the content; identifying, purchasing/renting, installing, and/or activating an application capable of displaying the content; identifying and/or updating the intellectual property rights necessary to access the content; retrieving and/or ensuring compliance with other digital rights management (DRM) requirements; and/or retrieving any other information needed to access the content, according to one exemplary embodiment.

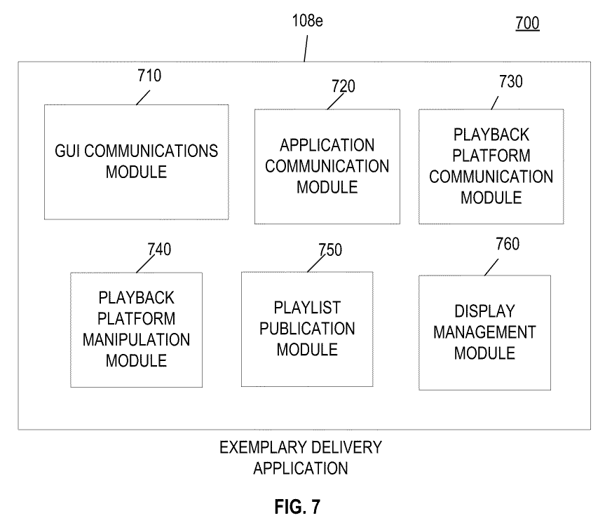

FIG. 7 depicts a diagram 700 illustrating an exemplary embodiment of a delivery application 108e. The delivery server 108e, in an exemplary embodiment, may include, e.g., but is not limited to, a GUI communication module 710, an applications communications module 720, a playback platform communication module 730, a playback platform manipulation module 740, a playlist publication module 750 and/or a display management module 760, etc.

The GUI communication module 710, in an exemplary embodiment, may facilitate communications between, e.g., the delivery application 108e and the GUI 402. The GUI 402 may enable a presenter 102b, 102d to, e.g., but not limited to, publish and/or deliver a playlist in conjunction with the delivery application 108e.

The application communication module 720, in an exemplary embodiment, may facilitate the communication between the delivery application 108e and one or more or the remaining applications 108.

The playback platform communication module 730, in an exemplary embodiment, may enable the delivery application 108e to, e.g., but not limited to, determine the capabilities of the playback platform 104c, 104e. In an exemplary embodiment, capabilities of the playback platform 104c, 104e may refer to, e.g., but are not limited to, the playback platform's display limitations, available bandwidth, degree of possible interactivity, available memory, connectivity method, hardware and/or software configuration and/or available software, etc. The playback platform's capabilities may be used by the format server 108b, as described above.

The playback platform manipulation module 740, in an exemplary embodiment, may enable the delivery application 108e to, e.g., but not limited to, prepare the playback platform 104c, 104e to receive the playlist 408. The playback platform may be prepared by, e.g., but not limited to, loading software necessary to display the playlist 408 and/or allocating resources necessary to open/display the playlist, etc.

The publication module 750, according to an exemplary embodiment, may enable the presenter 102b, 102d, via delivery application 108e, to, e.g., but not limited to, publish a playlist 408. Publishing the playlist 408 may include, e.g., but is not limited to, formatting the playlist 408 for distribution, formatting the playlist 408 to be displayed on a playback platform 104c, 104e, associating an access control list with the playlist 408, emailing the playlist 408, and/or posting the playlist 408 on, e.g., but not limited to, storage, a personal website, a commercial website, a government website, a non-profit website, a social networking website, and/or an internet based application, etc. A published playlist 408 according to an exemplary embodiment may include, e.g., but not limited to, audio, video, or audio and video etc.

In an exemplary embodiment, formatting the playlist 408 for distribution may include, e.g., but is not limited to, flattening the playlist, imbedding the playlist in a real-time communication stream, and/or enabling the playlist 408 for automatic playback etc.

Flattening, according to an exemplary embodiment, may include, e.g., but is not limited to, flattening the playlist into a single file, converting the playlist into an interactive format (such as, e.g., flash) and/or flattening the playlist into a given format (such as, e.g., a compressed format), etc. Flattening a playlist may facilitate the display of the playlist on one or more playback platforms and/or the distribution of the single file, or group of files, to one or more playback platforms. In addition, flattening the file, according to an exemplary embodiment, may enable a playback platform 104 to display the playlist without the need for the unified presentation system. In an exemplary embodiment, the playlist may be flattened and/or distributed, etc., according to an exemplary embodiment, via, e.g., but not limited to, an audio podcast, a video podcast, a movie file (such as, e.g., but not limited to, a Quicktime file, and/or a Flash file, etc.), a live universal resource locator (URL), television, internet protocol (IP) television, a format for embedding in a social networking environment (e.g. Facebook, Myspace, etc.), a rich media website (web 2.0), PDF, and/or real simple syndication, (RSS), etc.

Imbedding the playlist 408 in a real-time communication stream may include, e.g., but is not limited to, transmitting a playlist in accordance with Extensible Messaging and Presence Protocol (XMPP), or other rich media message protocol, etc. The extensible markup language (XML)-based, XMPP was designed and is currently maintained by the Jabber Software Foundation of, according to an exemplary embodiment, transmitting a playlist in accordance with XMPP may include, e.g., but is not limited to, transmitting the playlist 408 as a streaming video and/or streaming audio.

According to an exemplary embodiment, enabling the playlist 408 for automatic playback may include, e.g., but is not limited to, allowing a first presenter 102b, 102d to “record” a live presentation of a playlist 408. The first presenter 102b, 102d may, e.g., but not limited to, record his/her preferred order (which may, or may not, follow the content order of the playlist 408), may choose preferences, settings, multiple tracks such as, e.g., but not limited to, a voice-over narration of the playlist, and/or pointer movements during the presentation, etc. By “recording” the live presentation, according to an exemplary embodiment, a second presenter 102b, 102d may be able to present the same playlist 408 while relying on the first presenter's navigation and narrations of the playlist 408. Thus, the second presenter 102b, 102d may not need to manually [if you can find it!] direct the presentation in real time. Further, according to an exemplary embodiment, playback by the audience 102c, 102e, may be enabled in the absence of the presenter 102b, 102d, at a different time than the time at which the original presentation was given.

In an exemplary embodiment, enabling automatic playback of a playlist may include, e.g., but is not limited to, recording or capturing the first presenter's live presentation (including, e.g., the sequence of displayed content, preferences, and/or settings, etc.), recording a voiceover or narration, editing the recording asynchronously, saving the playlist and voiceover recording as meta-tags, storing and/or publishing the playlist with the tagged metadata, etc.

In one exemplary embodiment, during publication, a user may select to control access to a playlist 408. In an exemplary embodiment, access may refer to, e.g., but is not limited to, the ability of the presenter(s)/audience member(s) to gain access to, open, and/or run all, none, or portions of the playlist, save all, none, or part of the playlist, read all, none, or part of the playlist, add/delete all or part of the content within a playlist, edit all, none, or part of the content within a playlist, edit the Autoplay order of the playlist, reorder all, none, or part of the content within a playlist, and/or redact all, none, or part of the content within a playlist 408.

According to an exemplary embodiment, access to all, none, or part of a playlist 408 may be based on, e.g., but may not be limited to, the content found within the playlist 408, digital rights management (DRM) requirements, service level agreements (SLAs), subscription levels, user type, user licenses, the date/time access to the playlist is requested, characteristics of the presenter(s)/audience member(s), presence/relevance information of the presenters/audience members, and/or categories of the presenter(s)/audience member(s). In an exemplary embodiment, content found within the playlist 408, may include, e.g., but is not limited to, copyrighted material, trademarked material, patented material, classified material, confidential material, public material, licensed material, and/or sales material, etc. In an exemplary embodiment, DRM may include tools to enforce the compliance with the access control requirements associated with the usage of digital media or devices. In an exemplary embodiment, the date/time access to the playlist may be requested and may include, e.g., but is not necessarily limited to, a time period, a duration, weekdays, weekends, holidays, business hours, after business hours, morning, and/or afternoon, etc. In an exemplary embodiment, characteristics of presenter/audience member(s) may include, e.g., but may not be limited to, an employee, a trusted employee, a non-trusted employee, a salesperson, a non-sales person, a non-employee, a former employee, a contract employee, a customer, a potential customer, a coworker, a friend, a category of user, and/or a business contact, etc. In an exemplary embodiment, a category of presenter/audience member(s) may include, e.g., but is not limited to, licensed, unlicensed, high-priority users, low priority users, users with security clearances, users without security clearances, paying users, and/or non-paying users, etc.

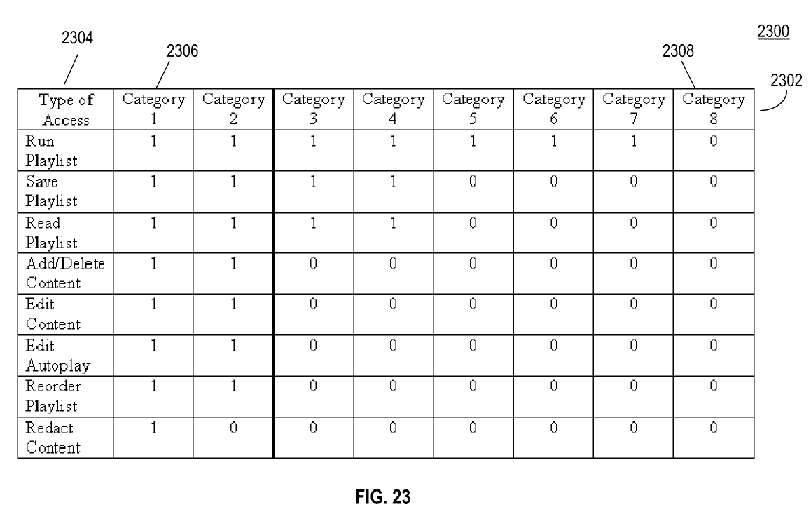

In an exemplary embodiment, access to all, none, or part of a playlist 408 may be controlled via, e.g., but not limited to, an access control table as described further below with reference to FIG. 23.

FIG. 23 depicts a table 2300 illustrating an exemplary embodiment of an access control list (ACL) table in which presenter(s)/audience member(s) may be assigned to one of eight categories in row 2302. In FIG. 23, according to an exemplary embodiment, presenter(s)/audience member(s) deemed entitled to the greatest or highest level of access may be assigned to Category 1. Presenter(s)/audience members(s) deemed entitled to the least or lowest level of access may be assigned to Category 8. The level of access of the presenter(s)/audience member(s)—see column 2304—may be based on the users assigned category. Users assigned to Category 1, for example, may have the highest level of access, as indicated by the amount of 1's in column 2306. Users assigned to Category 8, for example, may have the lowest level of access, as indicated by the amount of 0's in column 2308.

In an exemplary embodiment, a presenter(s) 102b, 102d may utilize the access control table 2300 of FIG. 23 to control audience access to their playlist. Audience members 102c, 102e may be required to register with the presenter 102b, 102d, and/or his/her agent, at which time the audience member 102c, 102e may be assigned to a category and an encrypted key may be exchanged. The encrypted key may then serve as the audience member's token for access rights and/or identification purposes. Categories may be assigned to user groups such as, e.g., but not limited to, social network groups of the creator 102a, 102f.

In an exemplary embodiment, a presenter may maintain a user database with access control attributes for a given individual audience member. A user database may enable audience member(s) to be assigned individual rights or profiles instead of being mapped to a particular user category rights profile.

According to an exemplary embodiment, a playlist 408 may be distributed based on the creator's presence information as well as the presence information of other users 102. Presence, which is described in further detail below, allows a user to indicate the user's current communication status. Communication status may include the user's ability to communicate in addition to how the user is able to receive communication (i.e. whether by computer, phone, video, etc.).

A playlist 408 may also be stored on, e.g., but not limited to, storage, an internet accessible database, a personal website, a commercial website, a government website, a non-profit website, a social networking website, and/or an internet based application, etc.

A playlist 408 may be sold via, e.g., but not limited to, a website, a personal website, a commercial website, a government website, a for-profit or non-profit website, a social networking website, an open content environment, and/or an internet based, online, and/or networked application, etc.

A playlist 408 may be distributed as a file, and may be configured in a read-only format, or may be in an editable format. When distributed in a read-only format, other users may not be permitted to add, delete, modify, and/or edit content from the playlist. When distributed in a editable format, end users may be able to access, add, delete, modify and/or edit content in the playlist. The ability of end users to access, add, delete, and/or edit content may be based on the presence, relevance, and/or access level of the end users. According to another exemplary embodiment, a link may be provided for distribution, for later access via the link to the controlled content.

Discuss display management module 760, in an exemplary embodiment, may prepare and manage the display of the playlist on the playback platform(s). Managing the display of the playlist may include, e.g., but is not limited to, coordinating the display of the playlist on multiple playback platforms, preventing an audience from viewing the playlist until the playlist is ready to be viewed without interruptions, and loading and/or queuing up applications in the background, unbeknownst to the viewing audience, to aid in the display or modification of content in the playlist.

Returning to FIGS. 1 and 2, web server application 108a, message application 108d, communication application 108f, security application 108g, presence application 108h, relevance application 108i, social/professional networking application 108j, and other application 108k may each work in cooperation with one another and with applications 108b, 108c, and 108e, as discussed above. Applications 108a, 108d, and 108f-108k, and even all 108, may be separate applications or may be combined within one or more combinations of other applications 108.

The web server application 108a in an exemplary embodiment may facilitate the communication between the devices and the applications.

The message application 108d in an exemplary embodiment may facilitate communication among the applications 108, etc.

The security application 108g in an exemplary embodiment may facilitate the establishment and/or maintenance of protective measures designed to ensure the safety of a playlist from hostile acts or influences.

The presence application 108h in an exemplary embodiment may facilitate the identification, distribution, and/or publication of playlists based on the presence information of users such as, for example, a play list creator and an audience member. The presence application 108h may also enable a user 102 to provide all, none, or part of his/her presence information. The presence application may also enable a user to view all, none, or part of the presence information of another user.

Presence 108 may allow an individual user to indicate the user's current communication status. Communication status may include, e.g., but is not limited to, an individual's availability to communicate (e.g., but not limited to, available, unavailable, out of the office, on vacation, do not disturb, out for lunch, gone for the day, at a particular location, etc.), the individual's willingness to communication (e.g., but not limited to, the user's mood, time constraints, etc.), how and whether the individual is capable of receiving communication (e.g., but not limited to, by computer, phone, video-conference, instant message (IM), a low bandwidth device, high bandwidth device, a secure device, an unsecure device, a mobile device, a display size, etc.), a user's security/authorization level, and/or the user's location (e.g., but not limited to, home, office, car, plane, etc.). Using an individual's presence information, a person seeking to contact an individual can decide how and/or when to initiate communication before an attempt is made to connect and/or communicate.

Presence 108h may encompass a plurality of different communication channels. The idea that multiple communication devices can combine state, to provide an aggregated view of a user's presence has been termed multiple points of presence (MPOP). Using MPOP, an individual user's actions may be automatically inferred from passive observation of the individual user's actions. For example, presence 108h can be used to determine if an individual's cell phone is on, whether the user is logged into their computer, or whether the user is in a “Muted” state, or in a “Roaming” state.

MPOP status can be used, according to an exemplary embodiment, to automatically direct incoming messages across all contributing devices. For example, an “Out of office” message status might translate to a system directing all messages and calls to the user's cell phone. The status “Do not disturb” might automatically save all messages for later access and send all phone calls to voicemail. XMPP, discussed above, facilitates MPOP by assigning each client or user a “resource” (a specific identifier) and a priority number for each resource. According to an exemplary embodiment, a message directly to the user's ID goes to the resource with highest priority, although messaging a specific resource may be possible by using the form user@domain/resource.

Presence 108h status is highly sensitive information and in non-trivial systems a “presentity” may define limits to which its presence information may be revealed to different watchers. For example, a worker may only want colleagues to see detailed presence information during office hours. Basic versions of this idea are already common in instant messaging clients as a “Blocking” facility, where users can appear as unavailable to selected watchers, such as, e.g., friends, family, and/or coworkers.

Presence, particularly MPOP as implemented by certain mobile cell phone operators, may require collaboration between a number of electronic devices (for example IM client, home phone, cell phone, and electronic calendar) and the presence services each of them are connected with. To date, the most common and wide-scale implementations use closed systems, with a Ssingle point of presence (SPOP), where a single device publishes state). Some vendors have upgraded their services to automatically log out connected clients when a new login request reaches a server from a newly connecting different device. In an exemplary embodiment, for presence to universally work with MPOP support, multiple devices must be able to not only intercommunicate among each other, but the status information must also be appropriately handled by all other interoperable, connected presence services and the MPOP scheme for their clients. Conventional 2.5G and 3G cell phone networks can support management and access of presence information services for mobile user's cell phone handsets. In the workplace, private messaging servers may offer the possibility of MPOP within a company or work team.

Presence information is a growing tool towards more effective and efficient communication within a business setting. Presence information may allow one to instantly see who is available in one's corporate network, giving more flexibility to set up short-term meetings and conference calls. The result of the user presence is precise communication that all but eliminates the inefficiency of phone tag or email messaging. According to IDC surveys, employees “often feel that IM gives their workdays the kind of ‘flow’ that they feel when sitting directly among their colleagues, being able to ask questions of them, and getting the kind of quick responses that allow them to drive on to the next task.”

The relevance application 108i, according to an exemplary embodiment, may facilitate the identification, distribution, and/or publication of relevant material. Relevant material may include, e.g. but are not limited to, playlists, advertising, content, program features, applications, etc. Relevant material may be identified based on relevance information. Relevance information may be related to, e.g., but is not limited to, a playlist creator 102a, 102f and/or an audience member 102c, 102e. Relevance information may be used to determine the relevance of various aspects of a playlist 408 to that user. Relevance information may include, e.g., but may not be limited to, presence information, as defined above; personal information, such as, e.g., but not limited to, an individual's career, hobby, marital status, family status, nationality, and/or location; content in playlists on that individual's computer; aspects of that individual's social network, etc.

The social/professional networking application 108j, according to an exemplary embodiment, may facilitate the creation and/or distribution of playlists and/or content via social and/or professional networking websites. The social/professional networking application 108j, in an exemplary embodiment, may enable a user to import a playlist 408 and/or content from a social and/or professional networking website where the playlist 408 and/or content was created by a different member of the social and/or professional networking website, exchange playlists 408 and/or content with other members of the social and/or professional networking website via the social and/or professional networking website, view playlists and/or content on the social and/or professional networking website, and/or add posted playlists 408 to an individual user's social and/or professional networking website. The social/professional network application 108j may also share member's presence and/or relevance information according to an exemplary embodiment. The social/professional network application 108j may also allow one to share and/or exchange playlists and/or share content, based on member's presence and/or relevance information, etc.

The application 108k, according to an exemplary embodiment, may provide further tools which may facilitate the access to, opening, modification, and/or editing of content by the unified presentation system. According to an exemplary embodiment, an application or applet, may be called by, e.g., but not limited to, the format application to help open content. According to an exemplary embodiment, content may be licensed, rented/purchased, and/or borrowed.

In another exemplary embodiment, various other applications may be included as would be apparent to those skilled in the art.

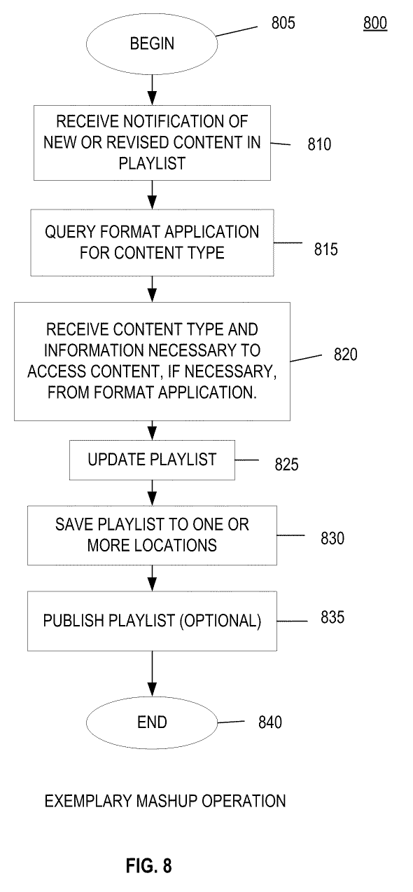

FIG. 8 depicts flow diagram 800 illustrating an exemplary embodiment of a flowchart for an exemplary technique by which the mashup application 108c may perform an exemplary operation combining disparately formatted, types of content. Flow diagram 800 may be referred to as a “mashup operation.” The exemplary operation of 800 may begin in block 805 and may proceed immediately to block 810.

In block 810, the mashup application 108c may receive, e.g., a notification that new content may have been placed in the playlist and/or that content already in the playlist has been edited. Flow 810, 800 may continue with 815.

In block 815, the mashup application 108c may query the format application 108b to determine the type of content in the playlist. From 815, 800 may continue with 820.

In block 820, the mashup application 108c may receive the type of content in the playlist, and/or information/application(s) needed to access the content, if necessary, from the format application 108b. The mashup application 108c may receive information needed to access the content if, for example, the content type has never been encountered before, if the content is associated with a type of digital rights management protocol, etc. From 820, 800 may continue with 825.

In block 825, the mashup server may update the playlist with the information received from the format application in block 820. From 830, 800 may continue with 835.

In block 830, the mashup application 180c may save the playlist to one or more storage locations. From 830, 800 may continue with 835.

In block 835, the mashup application 108c may publish the playlist. From 835, 800 may continue with 840 and may immediately end.

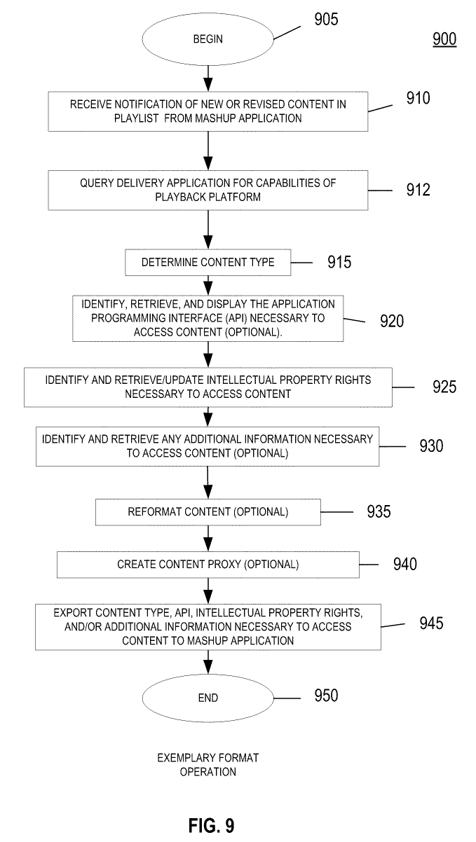

FIG. 9 depicts a flow diagram 900 illustrating an exemplary embodiment of a flowchart 900 for an exemplary technique by which the format application 108b may perform a format operation. The exemplary operation of 900 may begin in block 905 and may proceed immediately to block 910.

In block 910, the format application may receive notification that new content may have been placed in the playlist and/or that content already in the playlist may have been edited by the mashup application 108c. From 910, 900 may continue with 912.

In block 912, the format application 108b may query the delivery application for the capabilities of the playback platform. From 912, 900 may continue with 915.

In block 915, the format application 108b may determine the content type. From 915, 900 may continue with 920.

In block 920, the format application 108b may optionally identify and retrieve an application needed to access the content. In the event the proper application is already available, the format application need not retrieve another copy. From 920, 900 may continue with 925.

In block 925, the format application 108b may, e.g., identify, retrieve, and/or update intellectual property and/or DRM rights necessary to access the content. From 925, 900 may continue with 930.

In block 930, the format application 108b may, e.g., identify, retrieve, and/or update any additional information necessary to access the content. From 930, 900 may continue with 935.

In block 935, the format application 108b may reformat the content. The format application 108b may optionally reformat the content when, for example, a playback platform is unable to display the content in its native form due to, for example, the playback platform's lack of, e.g., available memory, software incompatibility, and limited bandwidth, etc. From 935, 900 may continue with 940.

In block 940, the format application 108b may optionally create a content proxy when, for example, the playback platform is unable to display the content in its native form due to, for example, the playback platform's lack of available memory, software incompatibility, and limited bandwidth. From 940, 900 may continue with 945.

In block 945, the format application 108b may export, e.g., the content type, the API, information concerning relevant intellectual property rights, and/or any additional information necessary to access the content to the mashup application. From 945, 900 may continue with 950 and may immediately end.

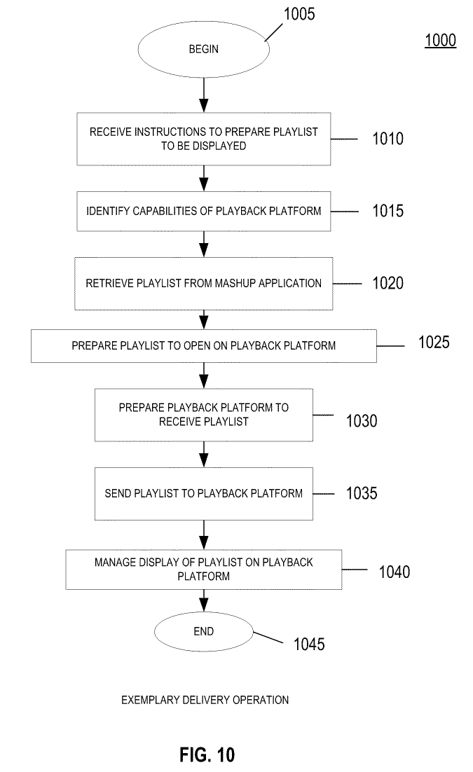

FIG. 10 depicts a flow diagram 1000 illustrating an exemplary embodiment of a flowchart 1000 for an exemplary technique by which the delivery application 108e may perform a delivery operation. The exemplary operation of 1000 may begin with block 1005 and may proceed immediately to block 1010.

In block 1010, the delivery application 108e may receive instructions to prepare a playlist to be displayed. From 1010, 1000 may continue with 1015.

In block 1015, the delivery application 108e may identify the capabilities of the playback platform. From 1015, 1000 may continue with 1020.

In block 1020, the playlist may be retrieved from the mashup application 108c. From 1020, 1000 may continue with 1025.

In block 1025, the delivery application 108e may prepare the playlist to be opened on the playback platform. From 1025, 1000 may continue with 1030.

In block 1030, the delivery application 108e may prepare the playback platform to receive the playlist. From 1030, 1000 may continue with 1035.

In block 1035, the delivery application 108e may send the playlist to the playback platform. From 1035, 1000 may continue with 1040.

In block 1040, the delivery application 108e may manage the display of the playlist on the playback platform. Managing the display of the playlist may include, e.g., but is not limited to, preventing an audience from viewing the playlist until the playlist is ready to be viewed without interruptions, and queuing up applications in the background, unbeknownst to the viewing audience, to aid in the display or modification of content in the playlist. From 1040, 1000 may continue with 1045.

In block 1045, the exemplary delivery operation may end.

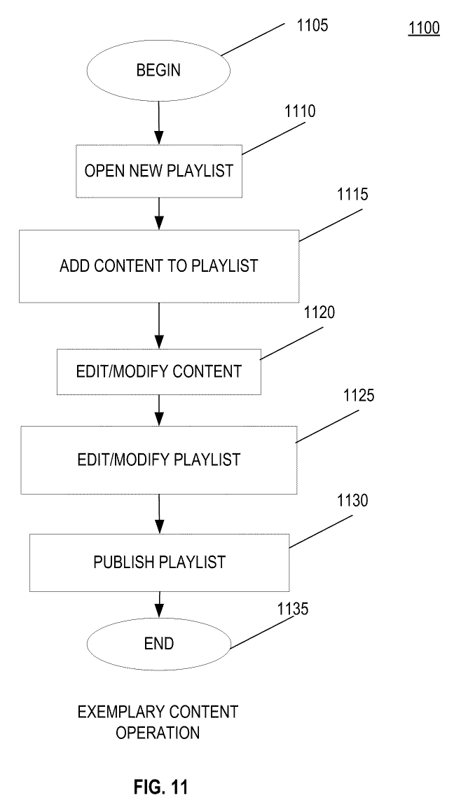

FIG. 11 depicts a flow diagram of 1100 illustrating an exemplary embodiment of a flowchart 1100 depicting an exemplary content operation, according to an exemplary embodiment of the present invention. The exemplary operation of 1100 may being in block 1105 and may proceed immediately to block 1110.

In block 1110, a presenter(s) may open a new, blank playlist 408 via a GU 402I. From 1110, 1100 may continue with 1115.

In block 1115, the presenter may add content to the playlist. As described above and below, content may be added to a playlist 408 via, e.g., but not limited to, a drag and drop operation, a pull-down menu, and/or an internet based application, etc. From 1115, 1100 may continue with 1120.

In block 1120, the presenter may edit/modify the content in the playlist. As described above and below, the presenter may edit the content in the playlist by, e.g., but not limited to, editing/modifying the content in the content's native form. From 1120, 1100 may continue with 1125.

In block 1125, the presenter may edit/modify the playlist. As described above and below, editing the playlist may include, e.g., but is not limited to, placing the content in an order to be displayed, identifying a portion(s) of individual content to be displayed, identifying content to be displayed/output simultaneously, adding transition sequences between content, and/or identifying where to begin displaying and where to end displaying content. From 1125, 1100 may continue with 1130.

In block 1130, the presenter may publish the playlist. As described above and below, publishing a playlist may include, e.g., but is not limited to, formatting the playlist for distribution, formatting the playlist to be displayed on a playback platform, associating an access control list with the playlist, and/or posting the playlist on, e.g., storage, a website, a personal website, a commercial website, a government website, a profit and/or non-profit website, a social networking website, and/or an internet based application, etc. From 1130, 1100 may end with 1135.

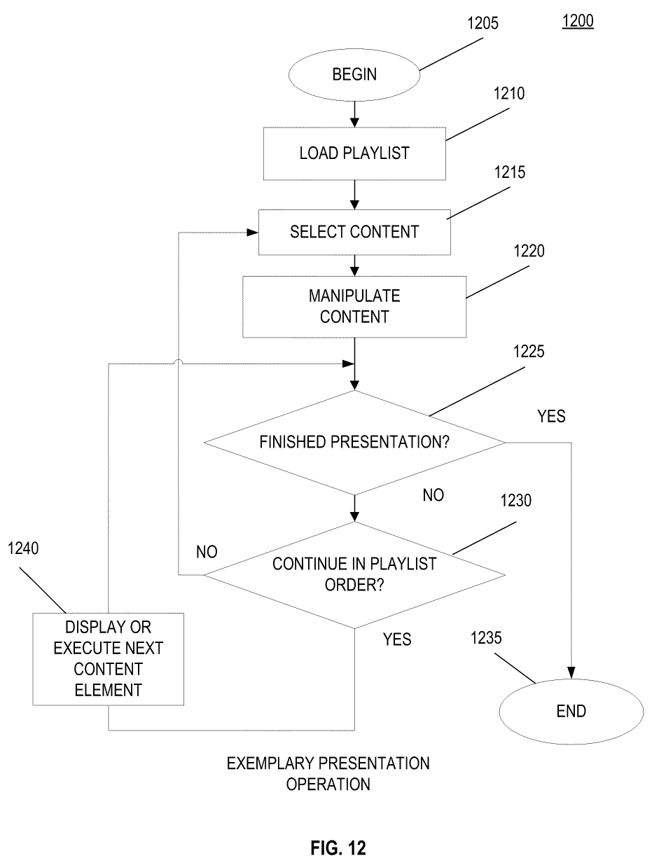

FIG. 12 depicts a flow diagram 1200 illustrating an exemplary embodiment of a flowchart 1200 depicting an exemplary presentation operation, according to an exemplary embodiment of the present invention. The exemplary operation of 1200 may begin in block 1205 and may proceed immediately to block 1210.

In block 1210, a presenter may load a playlist via a GUI 402. From 1210, 1200 may continue with 1215.

In block 1215, the presenter may begin presenting the playlist by selecting a starting point. A presenter may select the playlist content that the presenter wishes to present (e.g., display/execute) first. The presenter may select the first content in the playlist or select content appearing later in the playlist. From 1215, 1200 may continue with 1220.

In block 1220, the presenter may edit/modify the content being presented in the content's native form. From 1220, 1200 may continue with 1225.

In block 1225, the presentation of the playlist may be finished. A determination of completion may be made. If the presentation of the playlist is finished, the operation of 1200 may continue to block 1235, where the operation may end. If the presentation of the playlist is not finished, then 1200 may continue to 1230.

In 1230, the presenter may decide to continue presenting the playlist content in order. If the presenter decides to present the playlist content in order, the operation of 1200 may continue with block 1240. From 1240, 1200 may continue with 1225. If the presenter decides not to present the playlist content in order in 1230, the operation of 1200 may continue on to block 1215.

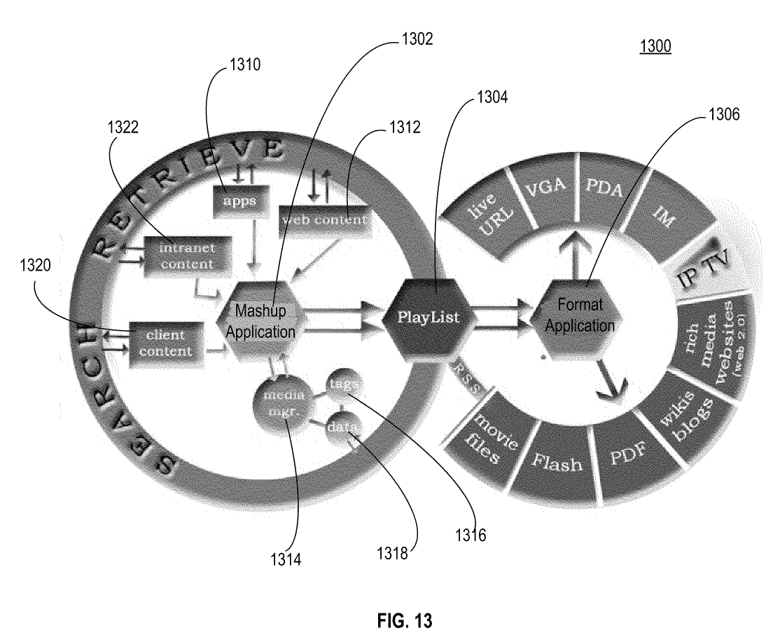

FIG. 13 depicts an exemplary diagram 1300 illustrating an exemplary embodiment of an exemplary unified presentation system environment according to an exemplary embodiment of the present invention. According to the exemplary embodiment, a mashup application 1302 may facilitate search for and retrieval content that may be placed in a playlist 1304. The playlist 1304 may then be formatted for presentation by format application 1306. As shown, format application 1306 may reformat and/or modify the content for delivery on a given specific platform or format.

According to an exemplary embodiment, the mashup application 1302 may search for and retrieve content which may be inserted into the playlist 1304.

According to an exemplary embodiment, the mashup application 1302 may contain a application tool 1310, a web content tool 1312, a media manager 1314, a client content tool 1320, and/or a intranet content tool 1322, etc.

The application tool 1310 may enable the mashup application 1302 to search for and retrieve content from external applications. Exemplary external applications may exist independently from the unified presentation system.

The web content tool 1312 may enable the mashup application 1302 to search for and retrieve content from websites.

The media manager 1314 may enable the mashup application 1302 to manage media content in the playlist 1304. The media manager 1314 may manage media content in the playlist 1304 with the assistance of, e.g., tags tool 1316 and/or data tool 1318.

Client content tool 1320 may enable the mashup application 1302 to search for and retrieve client content. Client content may reside on, e.g., but is not limited to, a network drive, a hard drive, a secure website, and/or an external hard drive.

The intranet tool 1322 may enable the mashup application 1302 to search for and retrieve client content from an intranet source.

In an exemplary embodiment, format server 1306 may ensure that the content placed in the playlist by the mashup server 1302 is playable. Playlist content may be playable when it is able to be viewed by a playback platform. In order to ensure playlist content is playable, the format server 1306 may secure the necessary intellectual property rights, acquire software needed to play the playlist content on the playback platform, reformat the playlist content, create proxies of playlist content, modify playlist content, and/or download a necessary code component.

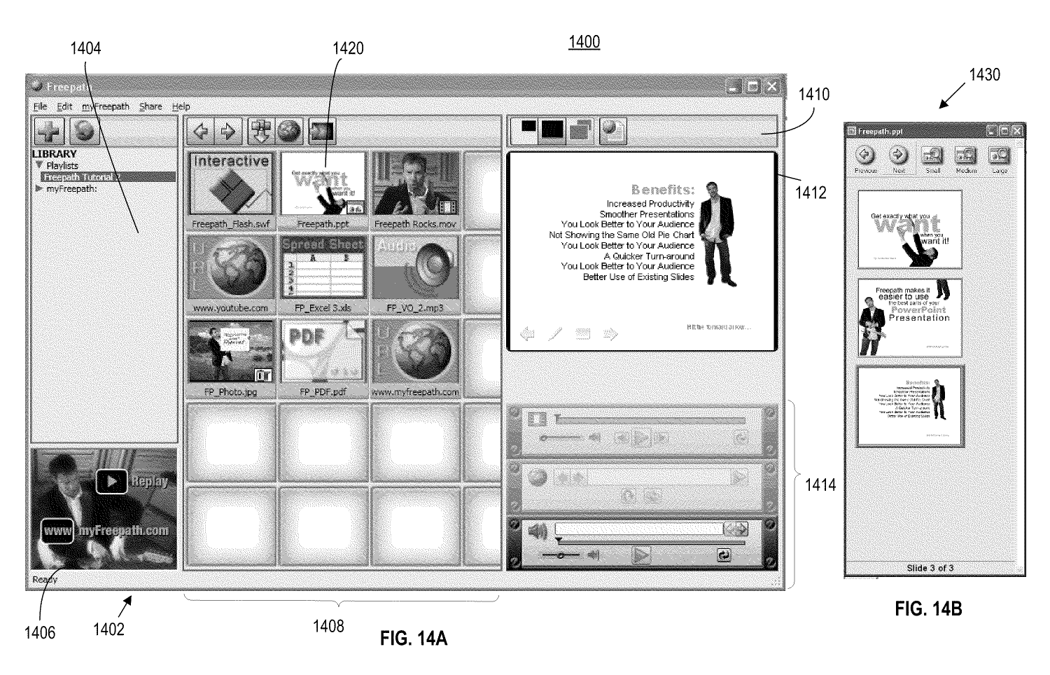

FIGS. 14A and 14B collectively depict a screenshot 1400 of an exemplary GUI 402 of a exemplary seamless playback of slides of content for an exemplary embodiment 1400 of a unified presentation system illustrating a presenter's view of a presentation program's slides in a seamless application environment, and the ability to preview slides prior to audience viewing. FIG. 14A depicts exemplary software for embodiment 1400 of unified presentation system. The exemplary embodiment 1400 of the unified presentation system 1400 may be in the form of a GUI 1402. GUI 1402 may contain, e.g., but is not limited to, a library 1404, an information space 1406, a playlist 1408, display controls 1410, a preview window 1412, and content controls 1414.

An exemplary embodiment preview window 1412 may preview selected content 1420 of a presentation, prior to the audience's viewing of, e.g., a slide. In FIG. 14A, content 420 may be a PowerPoint presentation. FIG. 14B depicts an exemplary pop-up window 1430. Exemplary pop-up window 1430, may preview selected content 1420.

Selected content 1420, in FIG. 14B, may be a PowerPoint presentation accessed with the presentation system common user interface.

FIG. 14B, depicts an exemplary pop-up window 1430. Exemplary pop-up window 1430 may allow a presenter to preview content 1420 once content 1420 is selected, but prior to displaying the viewer audience (i.e., the audience view would only see the contents of slide 412).

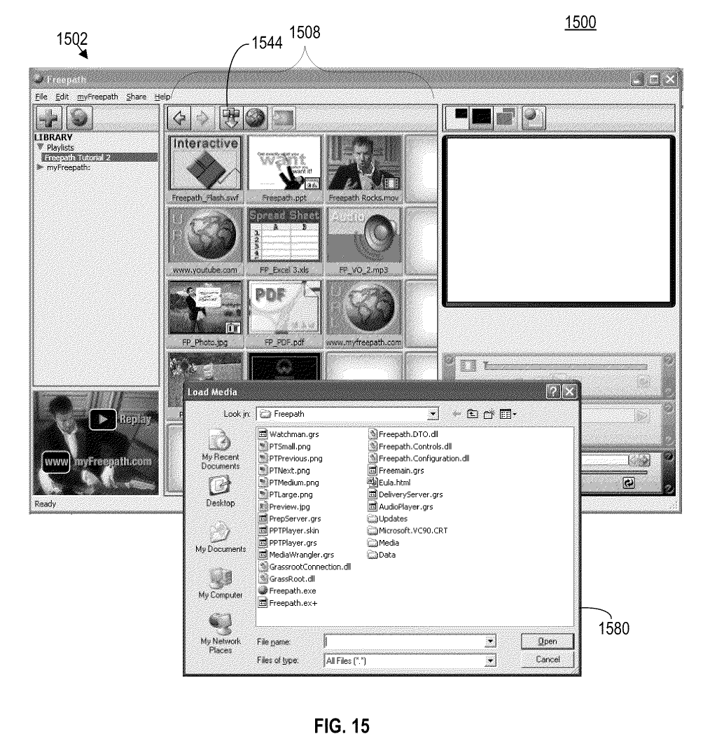

FIG. 15 depicts an exemplary screenshot of an exemplary GUI illustrating an exemplary import via a browse for an exemplary embodiment 1500 of a unified presentation system illustrating importing content into playlist 408. The exemplary embodiment 1500 of the unified presentation system may be in the form of a GUI 1502. GUI 1502 may contain, e.g., but is not limited to, a playlist 1508. A presenter may add or load content into playlist 1508 via icon 1544. The presenter 102b, 102d or creator 102a, 102f may add content to playlist 1508 by selecting icon 1544. Once selected, icon 1544 will result in the opening of exemplary pull-down menu 1580. The presenter 102b, 102d or creator 102a, 102f may add content to playlist 1508 by selecting content from browse window 1580. In an alternative embodiment, a presenter 102b, 102d may drag and drop content into playlist 1508. Once imported, a content element may be moved to the chronological location within the playlist desired by the presenter 102b, 102d.

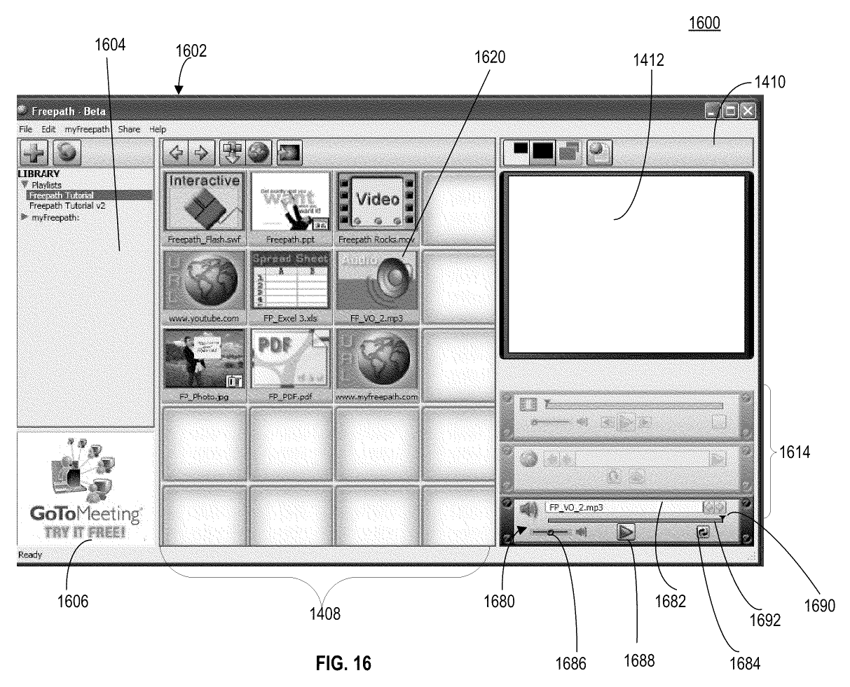

FIG. 16 depicts an exemplary screenshot 1600 illustrating an exemplary embodiment 1600 of a unified presentation system being used to play an audio content element via an exemplary rack control. The exemplary embodiment 1600 of a unified presentations system may be in a form of a GUI 1602. GUI 1602 may contain, e.g., but is not limited to, a library 1604, an information space 1606, a playlist 1608, a display controls 1610, a preview window 1612, and exemplary content controls 1614.

In the exemplary embodiment 1600 of the unified presentation system, a presenter may have selected exemplary content 1620 in playlist 1408 of GUI 1602. Once content 1620 is selected, audio controls 1680 may become active.

Audio controls 1680 and/or a menu, or GUI button or selector (not shown) may enable a presenter 102b, 102d to, e.g., select a starting point for the presentation of the audio file 1620, an ending point for the presentation of audio content 1620 and/or the simultaneous output of audio content 1620 by allowing the content to play while selecting other content elements of playlist 1408. Other control elements may include, e.g., but not limited to, modifying the volume of the audio being played back via slidebar 1686. Progress bar 1690 may indicate graphically the stage of the playback of the exemplary audio content. A change of begin or end, of cutin, or cutout may also be provided.

Exemplary audio controls 1680 may also, e.g., but not limited to, allow a presenter to select audio in window 1682, automatically replay selected audio content with icon 1684, control presentation volume in icon 1686, play a selected audio content with icon 1688, and/or select a starting/ending point for the presentation of audio.

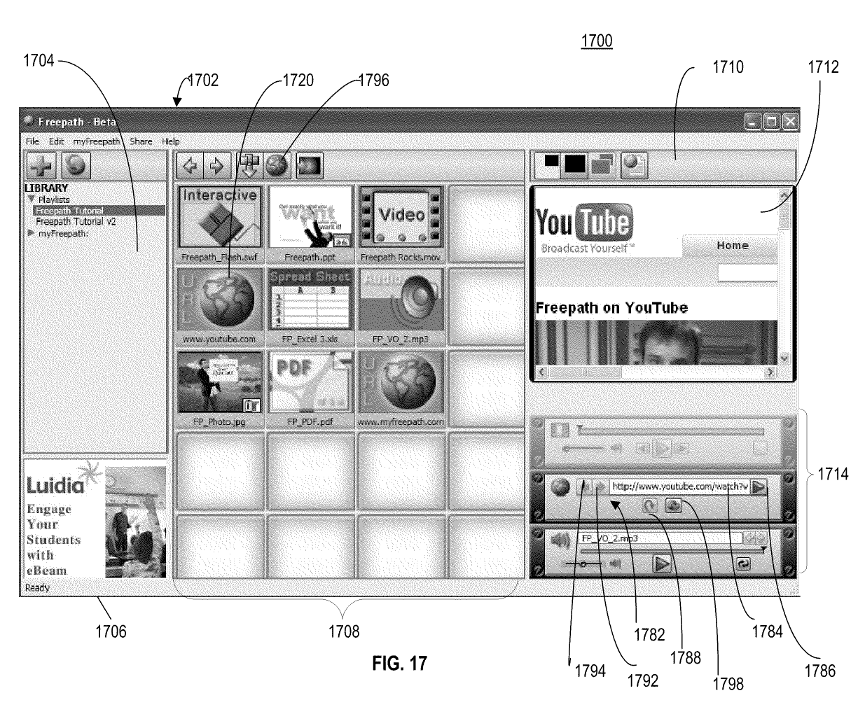

FIG. 17 depicts an exemplary embodiment of a screenshot 1700 of an exemplary unified presentation system illustrating access to a universal resource locator (URL) web content link via a browser URL address content control. The exemplary embodiment 1700 of a unified presentation system may be in the form of a GUI 1702. GUI 1702 may contain, e.g., but is not limited to, a library 1704, an information space 1706, a playlist 1708, display controls 1710, a preview window 1712, and content controls 1714.

In the exemplary embodiment 1700 of the unified presentation system, e.g., a presenter 102b, 102d may select internet content 1720 and by entering a URL. Once internet content 1720 has been selected, internet controls 1782, may become active.

Exemplary internet content controls 1714 may include, e.g., control 1786, which may be selected to fetch the hypertext markup language (HTML) document associated with an entered URL, to allow a presenter 102b, 102d to retrieve the internet site content associated with the linked URL entered in window 1784. Additional controls 1714 may include, e.g., but not limited to, display an internet website with icon 1786, to reload a selected internet site using icon 1788, add a new internet website to a playlist using icon 1790, to go forward using icon 1792, and to go backwards using icon 1794.

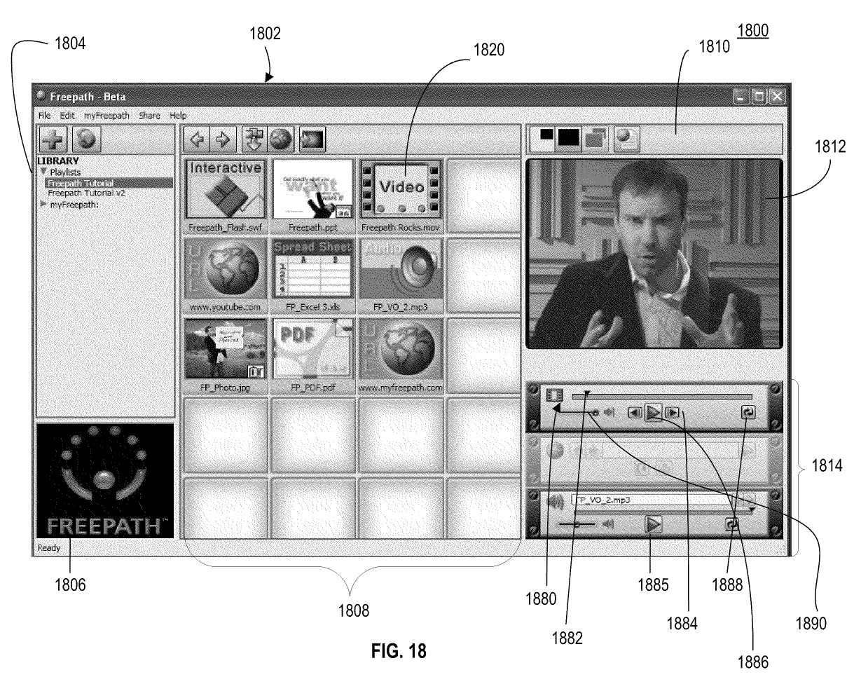

FIG. 18 depicts an exemplary screenshot of 1800 of an exemplary embodiment of a unified presentation system illustrating an exemplary video control 1814. The exemplary embodiment 1800 of the unified presentation system may be in the form of GUI 1802.

GUI 1802 may contain, e.g., but is not limited to, a library 1804, an information space 1806, a playlist 1808, content controls 1810, presentation window 1812, and content controls 1814.

In exemplary embodiment 1800 of the unified presentation system, a presenter 102b, 102d may select video content element 1820 in GUI 1802. Once video content 1820 is selected, video controls 1880 may become active.

Exemplary video control 1880 may become available. Exemplary audio controls 1880, in on exemplary embodiment, may allow a presenter to view the progress of video on slide by 1882, to select a starting point for the presentation of the video content 1820 or an ending point for selected video content 1820 via controls or menus (not shown), move forward by one or more frames by icon 1884, move backward by one or more frames icon 1885, play video content 1820 via icon 1886, automatically replay video content 1820 via icon 188, and/or, select a presentation volume via slide bar 1890.

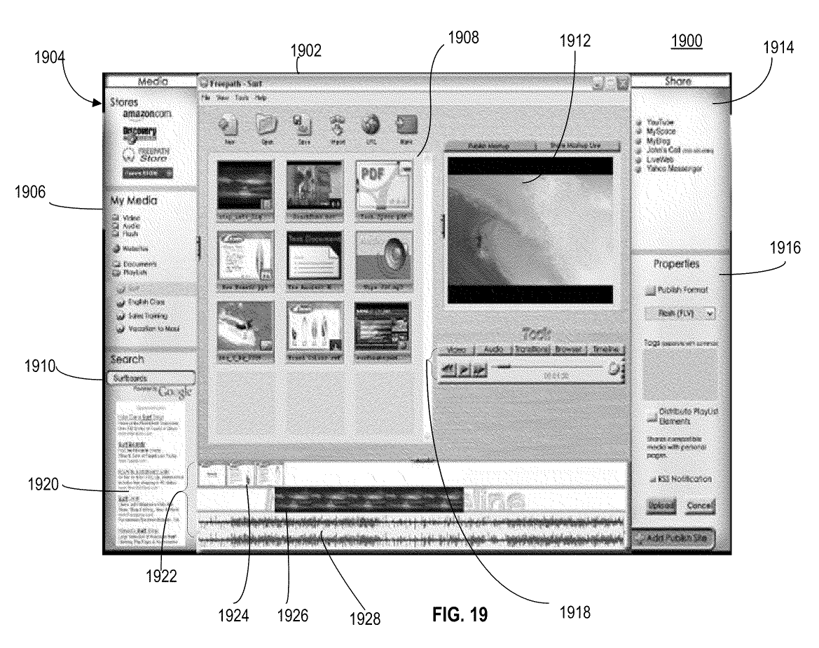

FIG. 19 depicts an exemplary screenshot of an exemplary software embodiment 1900 of a unified presentation system. The exemplary embodiment 1900 of the unified presentation system may be in the form of a GUI 1902. The GUI may contain, e.g., but is not limited to, a media store 1904, my media 1906, an internet search query box 1908, an advertisement or search results window 1920, a playlist 1910, a preview window 1920, a share window 1914, a properties window 1916, and media controls 1918.

According to one exemplary embodiment the search query tool 1908 may analyze the optional search server platform to maximize search result revenue for the application service provider.

Media store 1904, according to an exemplary embodiment, may allow a presenter to purchase, sell and/or license content and/or playlists from an internet based application and/or from another presenter. Content and play lists may be searched in one exemplary embodiment. A presenter 102c, 102d may then present the purchased and/or licensed playlist/content to an audience 102c, 102e and/or incorporate the playlist and/or content into playlist 1908.

My media window panel 1906, according to an exemplary embodiment, may allow a presenter to organize content. Content may be organized, e.g., but is not limited to, by content type. Exemplary content types may include, e.g., but are not limited to, video, audio/websites, documents, playlists, etc.

Internet search query box 1910 may allow a presenter or creator of a presentation to search for, identify, retrieve, license and add content to a playlist 1908 from the internet, or from a playlist provider services site, or a content store site.

Advertisement window 1920 or search results or sponsored links window may display internet advertisements, sponsored links which may be displayed and/or tailored to optimize and/or maximize service provider revenue. The internet advertisements may be selected based on the content of playlist 1910 and/or the advertising content may be tailored to the user, i.e., e.g., the creator's, presenter's, and/or audience members's presence, relevance, demographic, and/or psychographic information.

Preview window 1912 may display a preview of selected content from playlist 1910.

Share window 1914 may allow a presenter to publish playlist 1908 and share the published playlist 1908 with other presenters. A presenter may publish playlist 1908 via, e.g., but not limited to, Flash, Quicktime, Facebook, YouTube, MySpace, MyBlog, Liveweb, Yahoo! Messenger, email, XMPP, an Instant Messenger, syndication, and/or an RSS feed.

Property window 1916 may allow a presenter to edit content selected from the playlist 1910. A presenter may edit and/or modify content selected from playlist 1910 by selecting a published format, adding tags, distributing playlist elements, and/or selecting an RSS notification.

In exemplary multi-track window 1922 a presenter may view/edit a story board of an order of sequence in which playlist 1908 may be displayed/executed. For example in multi-track window 1922 a presenter may indicate an order in which visual content is to be displayed or audio content is to be heard. A presenter may also indicate what content is to be displayed in overlap, and/or simultaneously in the exemplary embodiment of the exemplary multi-track window 1922. For example, the exemplary embodiment of the multi-track window 1922 indicates that a slide content 1924, a video content 1926, and audio content 1928 may be presented with an overlap and/or simultaneously. Auto playback recorder controls may be provided in content control 1918, to allow recording a playlist for later storage and/or playback

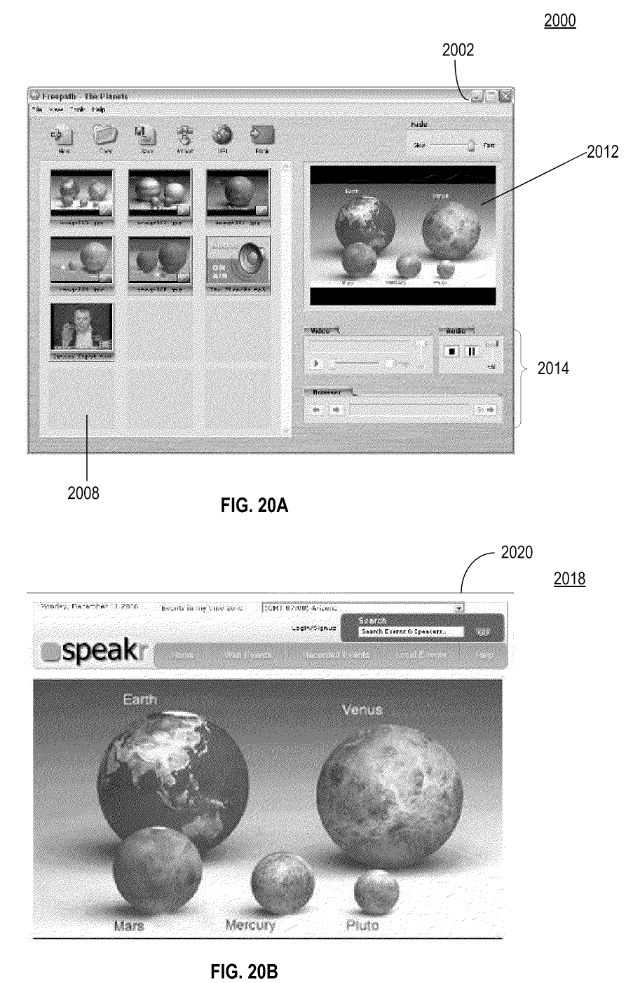

FIGS. 20 A and 20B depict exemplary screenshots 2000, 2018 of an exemplary software embodiment 2000 of a unified presentation system, illustrating presenter and audience views. The exemplary embodiment 2000 of the unified presentation system may be in the form of GUI 2002.

The GUI 2002 may contain e.g. but is not limited to a playlist 2008, a preview window 2012 of an audience view and content controls 2014.

In exemplary embodiment 2000 of the unified presentation system a presenter 102b, 102d may present playlist 2008, via GUI 8002, to an audience 102c, 102e. While the presenter 102b, 102d is presenting playlist 2008 the presenter 102b, 102d may view GUI 2002 as shown in screenshot 2000. Preview window 2012 may preview the presentation of playlist 2008 for the presenter. In another exemplary embodiment, preview window 2012 may indicate the view the audience is presently viewing as an audience view 2018. During the presentation of the playlist 2008 the audience 102c, 102e may see display window 2020 of audience view screenshot 2018. The audience may not see GUI 2002, but instead may now see the contents of 2012.

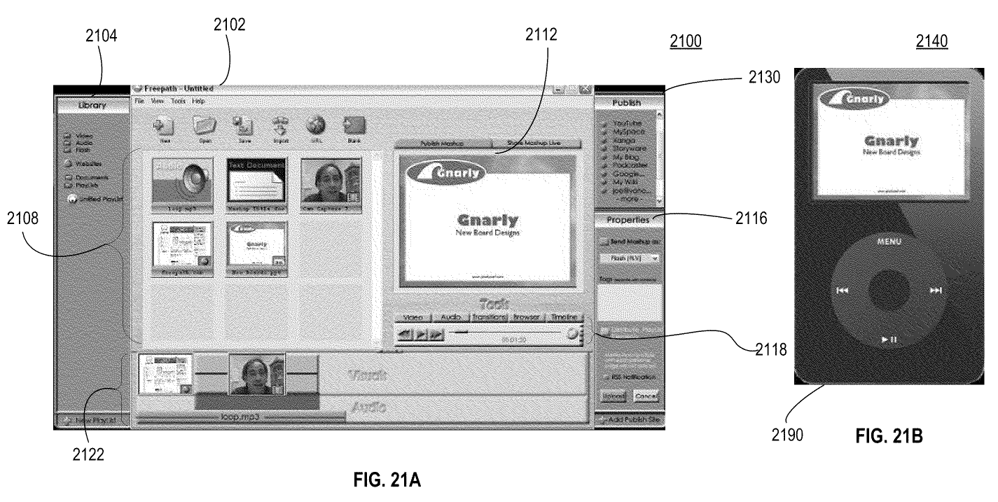

FIGS. 21A and 21B depict exemplary screenshots 2100, 2140 of an exemplary embodiment 2100 of the unified presentation system illustrating preview of content formatted for delivery for an exemplary digital content storage and playback device. The exemplary embodiment 2100 of the unified presentation system may be in the form of GUI 2102.

GUI 2102 may contain e.g. but is not limited to a playlist 2108, a preview window 2112 and content controls 2118, properties window 2116, track window 2122 and publish window 2130.

Publish window 2130 may allow a presenter 102b, 102d to publish playlist 2108. A presenter 102b, 102d may publish playlist 2108 to a given delivery format which may include, e.g., but not limited to, Facebook, Flash, QuickTime, YouTube, MySpace, Xanga, Storeware, a Virtual World, MyBlog, Podcaster, Google, MyWiki, and/or email to, e.g., Joe@yahoo.com, etc. The playlist 2180 may be published as a “flattened” file. The content may be formatted for delivery. The content may be compressed. The content may be made secure, and/or encrypted. The content may be encapsulated so as to enforce access controls.

FIG. 21B depicts a screenshot 2140 of an exemplary playback platform 2190 which may be, e.g., but it not limited to, a digital storage and auto playback device, such as, e.g., an ipod available from Apple Corporation. Exemplary playback platform 2190 may display the playlist 2180 and/or content which may have been published as an audio and/or video podcast. Exemplary playback platform 2190 may display a “flattened” version of the playlist 2108.

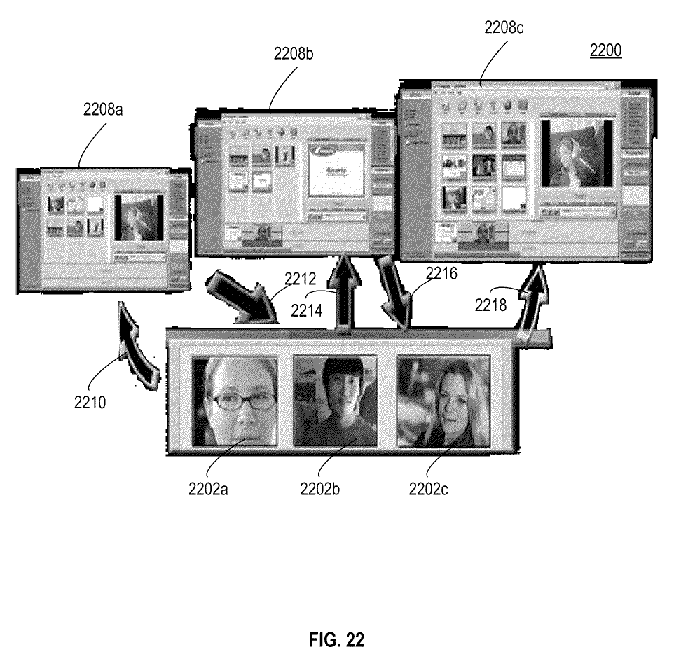

FIG. 22 depicts 2200 a screenshot of an exemplary diagram 2200 of an exemplary of a diagram illustrating an exemplary collaborative authoring process 2200 of a exemplary electronic playlist presentation of an exemplary embodiment of a unified presentation system. The exemplary collaborative authoring 2200 may involve, e.g., but is not limited to, a first presenter 2202a, a second presenter 2202b, and/or a third creator 2202c, etc.

In 2210, the first presenter 2202a may create a playlist 2208a. In 2212, the first presenter 2202a may make the playlist 2208a available to presenter 2202b.

In 2214, the second presenter 2202b may collaboratively edit/modify the playlist 2208a and/or the content within the playlist 2208a to create a revised playlist 2208b. In block 2216, the second presenter 2202b may make playlist 2208b available to the third presenter 202c. In an exemplary embodiment, changes may be annotated for later review.

In 2218, the third presenter 2202c may also edit/modify the playlist 2208b and/or the content within the playlist 2208b to create a revised playlist 2208c.

Playlists 2208a and 2208c may be made available to other presenters via, e.g., but not limited to, email, RSS feed, or posting the playlist on, e.g., storage, a website, a personal website, a commercial website, a government website, a profit and/or non-profit website, a social networking website, and/or an internet based application.

FIG. 23 is described above between FIGS. 7 and 8.

The embodiments illustrated and discussed in this specification are intended only to teach those skilled in the art the best way known to the inventors to make and use the invention. Nothing in this specification should be considered as limiting the scope of the present invention. All examples presented are representative, exemplary and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A graphical user interface (GUI) application embodied on a computer readable medium, which when executed on a processor performs a method comprising:
receiving a playlist comprising a plurality of content of a plurality of different formats; and
enabling a presenter to seamlessly deliver a presentation of said plurality of content to an audience.

2. The GUI of claim 1, wherein said receiving comprises:
receiving by a drag and drop interaction with a user said plurality of content being dropped on the GUI.

3. The GUI of claim 1, wherein the method further comprises:
allowing a change in order of said content of said playlist by drag and drop interaction of the user.

4. The GUI of claim 1, wherein the method further comprises:
providing a preview display for the presenter to view what the audience will see, wherein said preview display comprises at least one of:
a picture in a picture window;
a blank shade; or
a fullscreen window.

5. The GUI of claim 1, wherein said enabling comprises:
receiving from the presenter an indication to proceed from a currently presented content of said plurality of content, to another of said plurality of content;
identifying a format of said plurality of different formats, associated with the another of said plurality of content;
activating in the background an instance of an application associated with the another of said plurality of content; and
delivering for display using a common user interface the another of said plurality of content for viewing by the audience, once said instance is activated and the another said plurality of content is ready for display.

6. The GUI of claim 1, wherein the presenter comprises at least one of:
a creator;
a teacher;
a sales person;
a business person;
a professor;
a filmmaker;
a student;
a trainer;
a speaker;
a homemaker
a user;
a worship leader;
a pastor;
a medical professional;
an accountant;
a certified public accountant (CPA);
a legal professional;
a government Employee;
a military serviceman;
a politician;
a volunteer;
a non-profit employee;
an employee;
an artist;
a musician;
a writer;
a graphic designer;
a broadcaster;
a gamer;
a virtual persona;
an avatar;
a podcaster;
a spammer;
a blogger;
a disc jockey;
a web designer;
a software developer;
an entrepreneur;
an athlete;
a coach;
a administrator;
a sole proprietor;
a marketer;
a network marketer;
a scientist;
an administrative assistant;
a researcher;
an executive;
an analyst;
a research analyst;
a broadcaster;
a video disc jockey; and
a theater operator.

7. The GUI of claim 1, wherein the method further comprises:
interacting with an online collaboration service enabling at least one of:
sharing of content among a plurality of users;
storing of said playlist of said plurality of content;
storing said plurality of content;
viewing a published presentation of said playlist of said plurality of content;
providing content to another user;
receiving content from another user;
providing presence information about a user; or
providing relevance information about a user.

8. The GUI of claim 1, wherein the method further comprises:
providing relevance information about a user.

9. The GUI of claim 8, wherein said providing relevance information comprises at least one of:
providing presence information;
providing a user identifier of the viewing user;
providing a delivery format associated with a viewing device of a viewing user;
providing an availability of the viewing user;
providing a location of the viewing user;
providing a security level of the viewing user;
providing status information of the viewing user; or
providing an encryption level of the viewing user.

10. The GUI of claim 1, wherein said plurality of different format types of said plurality of content comprises:
video content;
audio content;
audio-visual content;
image based content;
streaming content;
spreadsheet content;
still content;
animated content;
movie content;
programming content;
television content;
digital versatile disk (DVD) content;
portable document format (PDF) content;
rich media website content;
WEB 2.0 content;
WEB 3.0 content;
Voice-over-Internet Protocol (VoIP) content;
broadcast content;
FLASH-based content;
slide show content;
presentation slide content;
MS POWERPOINT content;
BLOGs;
sales information content;
web-based content;
xML or HTML content;
distance learning content;
product information content;
multimedia content;
corporate communications content;
network marketing content;
collaborative meeting content;
online community content;
social networking content;
virtual world content;
instant messaging content;
electronic mail content;
messaging content;
SMS and MMS messaging content;
music content;
sound effects content;
stock photo content;
background content;
online presentation content; or
podcast content.

11. The GUI of claim 1, wherein said enabling comprises:
providing a presenter view of said plurality of content; or
providing an audience view of said plurality of content.

12. The GUI of claim 1, wherein said method further comprises:
providing advertising content to the presenter.

13. The GUI of claim 12, wherein said providing advertising comprises at least one of:
providing advertising targeted at the presenter;
providing sponsored advertising;
providing banner advertising; or
providing reach media format advertising.

14. The GUI of claim 1, wherein said method further comprises:
providing a media store for purchase of content by the presenter.

15. The GUI of claim 1, wherein said method further comprises:
providing a media store for purchase by the presenter of licensed content owned by third parties including content affiliates.

16. The GUI of claim 1, wherein the method further comprises:
delivering interactively by the presenter, for display using a common user interface content for viewing by the audience, comprising at least one of:
identifying a device format of the audience;
formatting said content for said device format; or
delivering said content in said device format to the audience.

17. The GUI of claim 16, wherein said device format comprises at least one of:
a personal digital assistant format;
a browser format;
a computer display format;
a communications device display format;
a telephony device display format;
a display device format;
a VGA format;
a SVGA format;
an XVGA format;
a megapel format;
an HDTV format;
a DVI format;
an NTSC format; or
a PAL format.

18. A method for formatting content on a distributed computing environment, the method comprising the steps of:
receiving into a playlist a plurality of content of a plurality of different formats from a user via a user interface; and
enabling a presenter to seamlessly deliver a presentation of the plurality of content to an audience.

19. The method of claim 18, further comprising:
determining the capabilities of a playback platform;
preparing the plurality of content based on the capabilities of the playback platform.

20. The method of claim 18, further comprising:
opening the playlist;
displaying the content on a playback platform; and
managing the displaying of the content on the playback platform.

21. The method of claim 18, further comprising:
preparing the playback platform to display the plurality of content of the playlist.

22. The method of claim 20, wherein said preparing comprises:
identifying a format associated with at least one of the plurality of content;
activating, in the background, an instance of an application associated with the at least one of the plurality of content; and
delivering for display the at least one of the plurality of content for viewing by the audience, once said instance is activated and the at least one of the plurality of content is ready for display.

23. The method of claim 19, wherein the first software program and the playback platform are located on a common devices.

24. The method of claim 19, wherein the first software program and the playback platform are located on separate device.

25. The method of claim 19, wherein the step of preparing the playback platform to display the plurality of content of a plurality of different formats comprises:
a unified presentation software application identifying, acquiring, and executing a second software program, wherein the second software program is needed to open one of the plurality of content.

26. The method of claim 19, wherein at least one of the plurality of content of a plurality of different formats is opened in unified presentation software application with the assistance of a second software application.

27. The method of claim 18, further comprising:
publishing the plurality of content.

28. The method of claim 27, wherein the publishing comprises at least one of:
formatting the plurality of content for distribution;
formatting the plurality of content for display;
flattening the plurality of content into a file;
flattening the plurality of content into a given format; or
flattening the plurality of content for purposes of at least one of:
displaying the plurality of content on one or more playback platforms; or
distributing the single file to one or more playback platforms.

29. The method of claim 27, further comprising:
publishing the playlist on at least one of a personal website, a commercial website, a government website, a non-profit website, a social networking website, or an internet based application.

30. The method of claim 18, further comprising:
storing the playlist on at least one of a personal website, a commercial website, a government website, a non-profit website, a social networking website, or an internet based application.

31. The method of claim 18, further comprising:
selling the playlist on at least one of:
a personal website,
a commercial website,
a government website,
a non-profit website,
a social networking website,
an open content environment, or
an internet based application.

32. The method of claim 18, wherein the plurality of content of a plurality of different formats relates to at least one of commercial information; training information; or
personal information.

33. The method of claim 18, wherein preparing a playlist is performed via at least one device.

34. The method of claim 18, wherein preparing a playlist is performed via a plurality of devices.

35. The method of claim 18, further comprises:
retrieving and complying with intellectual property rights for the various media files referenced in the playlist.

36. The method of claim 18, wherein the plurality of content of a plurality of different formats comprises at least one of:
syndicated content;
video content;
audio content;
text content; or
streaming content.

37. The method of claim 18, wherein the method is performed by at least one of:
a single machine running a process;
a single machine running multiple processes;
multiple machines running at least one process each; or
multiple machines running multiple processes.

38. The method of claim 18, further comprising:
saving the presentation in an internet accessible database.

39. A method for delivering content on a distributed computing environment, the method comprising the steps of:
determining the capabilities of a playback platform;
preparing the playback platform to display a playlist, comprising a plurality of content of a plurality of different formats, via a unified presentation software application, based on the plurality of content of a plurality of different formats and the capabilities of the playback platform;
preparing the plurality of content of a plurality of different formats to be displayed on the playback platform, via the unified presentation software application, based on the plurality of content of a plurality of different formats and the capabilities of the playback platform;
opening the playlist via the unified presentation software application;
displaying the playlist on the playback platform, via the unified presentation software application; and
managing the displaying of the playlist on the playback platform.

40. The method of claim 34, further comprising:
receiving the playlist based on at least one of:
relevance information about a user; or
presence information about a user.

41. The method of claim 34, further comprising:
receiving the playlist from at least one of:
a personal website,
a commercial website,
a government website,
a non-profit website,
a social networking website,
an open content environment, or
an internet based application.
